(19) United States
(12) Patent Application Publication
(10) Pub. No.: US 2012/0308239 A1
(43) Pub. Date: Dec. 6, 2012

(54) Active Tracking for Free-Space Optical Communication Systems

(76) Inventors: Samir S. Sheth, Plano, TX (US); Wayne E. Walters, Plano, TX (US); John C. Wissel, Allen, TX (US); Kelvin Hui Xu, Plano, TX (US); Brian E. Royal, Royse City, TX (US); Kelly P. Hawkins, McKinney, TX (US)

(21) Appl. No.: 13/486,880

(22) Filed: Jun. 1, 2012

Related U.S. Application Data
(60) Provisional application No. 61/493,354, filed on Jun. 3, 2011.

(51) Int. Cl. H04B 10/10

(52) U.S. Cl. 398/131

(57) ABSTRACT

Systems and methods enabling nodes of a free-space optical communication system to maintain pointing alignment of their transmitted optical beams. A first node scans its optical antenna through a path centered on a target direction. The second node captures signal strength measurements during the scan, and sends those measurements to the first node. The first node separately measures signal strength of the optical signal being received from the second node. The two sources of information (locally measured and remotely measured) are used to compute angular errors. The first node uses the angular errors to adjust the target direction of its optical antenna. The second node may employ the same method (with roles reversed) to adjust its target direction. By cycling back and forth between to the two nodes, the target directions of the two nodes maintain alignment in spite of movements of the structures on which they are mounted.

### RELATED APPLICATION DATA

This application claims the benefit of priority to U.S. Provisional Application No. 61/493,354, filed on Jun. 3, 2011, entitled “Active Tracking for Free-Space Optical Communication Systems”, invented by Sheth, Walters, Wissel, Xu, Royal and Hawkins, which is hereby incorporated by reference in its entirety.

### FIELD OF THE INVENTION

The present invention relates to the field of free-space optical communication, and more particularly, to a mechanism enabling optical communication systems to keep their optical antennas pointed at each other in spite of movements in the structures on which the optical antennas are mounted.

### DESCRIPTION OF THE RELATED ART

In the field of wireless communications, there are presently two types of systems prevalent in industry: radio frequency systems and optical frequency systems. The radio frequency systems operate at frequencies below 100 GHz. The optical systems operate at wavelengths from 860 nm to 10.6 μm. The main distinction between these types of systems is weather performance and government licensing rules and regulations.

Radio frequency (RF) systems include microwave and millimeter wave systems. The microwave systems typically have lower bandwidth but are more resistant to atmospheric effects such as rainfall and fog. The millimeter-wave systems in comparison have much higher bandwidths, supporting data rates in excess of 1.25 Gbps. However, millimeter-wave systems are impacted by rainfall but not fog. All of the RF systems are subject to FCC licensing rules and regulations, which may involve additional cost at licensed frequencies. Unlicensed RF systems are subject to interference, which leads to reduced data rates as multiple users may operate on those frequency bands simultaneously.

The optical systems are not subject to any of the FCC licensing rules. But optical systems are impacted by fog, and to a lesser degree by rain provided there is sufficient link margin. The light wavelengths typically utilized attenuate significantly in dense fog. Rain attenuation is typically about 20 dB/km for 100 mm/hr of rain. So, if there is sufficient link margin, an optical system can handle dense rainfall. There are typically no interference issues since the beams are narrow. As a result, they can be configured in parallel on the same link to increase the capacity.

In the current wireless/cellular market, with the advent of smart phones and tablet PCs, the demand for data capacity is high. However, the pricing does not reflect that demand due to high competition. The capacity is particularly stifled in the cellular backhaul. There is a demand for low cost, high capacity wireless systems.

Until recently, the cost of Gigabit systems has been relatively high. The optical systems start at $10K. The millimeter wave systems start at $20K. Even microwave systems with greater than 100 Mbps capacity are in this range. There exists a need in the market place for a low-cost optical system, e.g., one that can work in parallel with a radio system to provide large bandwidth capacity at a relatively low cost.

In the wireless market place, systems can be placed on top of structures such as buildings and cell towers. Such structures move when subjected to physical forces, e.g., forces due to wind, forces related to thermal expansion/contraction, forces related to the variations in tides, forces due to variable loading of a structure (e.g., a series of trucks passing over a bridge), etc. In the field of optical free-space communications, one major challenge in establishing reliable communications is keeping narrow laser beams on target in the presence of structural movement. For example, the systems can be deployed on top of buildings or even on communications towers and monopoles. (A monopole is a single pole such as the typical telephone pole or light pole.) The degree of instability rises as you go from building to towers and from towers to monopoles. As the degree of instability increases, it becomes increasingly more difficult to keep the beams on target.

One difficulty in maintaining alignment is because the laser beams used in at least some optical free-space communication systems are relatively narrow and much smaller than the amount of movement seen on structures. The laser beams typically have a width of 1 milliradian. Buildings can move as much as 1 milliradian an hour and +/−4 milliradians across the course of a day. Communications towers can move even more, with movements ranging from 0.5 degrees (8 mrad) to 3 degrees (50 mrad). The frequency components of the movement typically range from 0.1 Hz to 10 Hz. The lower frequency movements tend to have higher amplitude than the high frequency movements. But regardless of frequency range, there exists a need for mechanisms enabling optical communication systems to track each other as the structures on which they are mounted move.

Current optical communication systems for deployment on unstable structures are limited in their capability. They typically either keep the beamwidth wide and use higher transmit power, or use multiple lenses at the receiver to ensure a wide optical reception area. These crude solutions cause the cost of the optical communication system to increase.

### SUMMARY

In some embodiments, a local communication node and a remote communication node may communicate by transmitting and receiving optical signals through space. The local node may be configured to mechanically scan the pointing direction of its optical transmit antenna and/or its optical receive antenna. The local node makes measurements of its received signal strength during the scan. Those measurements may be used to compute angular errors of the pointing direction(s). The local node may then use the computed angular error to adjust its pointing direction(s). Alternatively, the remote node may make measurements of the strength of the local node's transmitted beam during the scan. The remote node may send those strength measurements to the local node over the optical communication link. The local node may use those remotely-acquired measurements to compute the angular errors. Again, the local node may adjust its pointing direction(s) based on the computed angular error. In some embodiments, the local node may use both the locally-acquired measurements and the remotely-acquirement measurements to compute the angular errors. Once the local node has adjusted its point direction(s), the local node and remote node may exchange roles, with the remote node performing the directional scan and pointing adjustment. By alternating back and forth continuously, each node may track the other node. In other words, the optical transmit antenna of each node may maintain the condition of being pointed approximately at the optical receive antenna of the other node in spite of the motion of both nodes. The local and remote nodes may be configured for broadband communication.

In some embodiments, each node has a single optical antenna to both transmit and receive, e.g., using wavelength division multiplexing (WDM).

In some embodiments, each node includes two optical antennas, one dedicated for transmission and the other dedicated for reception.

In some embodiments, each node may be configured for high-speed tracking by implementing the tracking algorithm in one or more programmable hardware elements (such as FPGAs) and/or in custom-designed circuitry such as one or more ASICs. High-speed tracking may be required when optical antennas are mounted on unstable structures.

In some embodiment, each node may be configured for lower-speed tracking by implementing the tracking algorithm in software using one or more processors. Lower-speed tracking may be acceptable when optical antennas are mounted on more stable structures such as buildings.

Each node may include two motors, one for adjusting a first coordinate of the pointing direction, and another for adjusting a second coordinate of the pointing direction. For example, the coordinate may be azimuth and elevation. However, the principles of the present inventions are not limited to any particular selection of coordinate system.

In some embodiments, each node may perform the pointing scan by moving the pointing direction in along a rectangular trajectory. Along each leg of the trajectory, one motor may rest while the other is active. Thus, power is conserved.

In some embodiments, each node includes two optical antennas, i.e., a receive antenna and a transmit antenna. The tracking algorithm may compensate for collimation errors between the two antennas.

In some embodiments, each node may make directional adjustments based on locally-acquired measurements until the pointing direction of each node has converged sufficiently for two-way communication over the optical communication link. Then, each node may transition to a mode where directional adjustments are based on remotely-acquired measurements as well as locally-acquirement measurements.

In one set of embodiments, a system and method for optical communication between two nodes (nodes A and B) may be arranged as follows.

Node A may include a communication services terminal CST_{A} coupled to an outdoor lens unit OLU_{A}, e.g., via a hybrid fiber-electrical cable. The OLU_{A} may have a single lens that is used both for transmission and reception. Alternatively, the OLU_{A} may have two lenses—one for transmission and the other for reception. Other lens numbers and configurations are contemplated as well.

In some embodiments, the CST and OLU may be combined into a single integrated unit, thus eliminating the cabling between the CST and OLU and increasing tracking speed.

The OLU_{A} also has motors (e.g., stepper motors) to control the pointing direction of the lens (or lenses). Node A drives the motors so that the pointing direction of the lens (or lenses) moves through a path (e.g., square or circular path) centered on a current target direction. Node A may perform this driving process while the optical data link between the two nodes is up and running, e.g., with both nodes sending and receiving optical signals through their respective lenses (or lens pairs).

Node B may be similarly equipped, with a communication services terminal CST_{B} coupled to an outdoor lens unit OLU_{B}. While node A is driving its lens/lenses through the path, node A may send to node B messages regarding where it is along the path. For example, when node A reaches the n^{th} waypoint in a sequence of predefined waypoints along the path, node A may send a message signaling that condition to node B. (These messages may be sent to node B through the optical data link.) Node B monitors its received optical signal strength during node A's traversal of the path. Node B sends the signal strength information or a condensed representation of the signal strength information to node A. For example, in one embodiment, node B measures signal strength for each of four quadrants along the path, and sends those quadrant-specific strength values to node A.

Node A may use the signal strength information (or the condensed representation of the signal strength information) to compute estimates of the azimuth deviation and elevation deviation of node A's current target direction from an ideal target direction. These estimates may be referred to as primary estimates.

Node A may also obtain secondary estimates of the azimuth deviation and elevation deviation of its current target direction. Node A may accomplish this by monitoring (i.e., measuring) its received signal strength while it is driving its lens/lenses through the path, and computing the secondary estimates from the monitored values of received signal strength. Node A may use the secondary estimates as well as the primary estimates to correct its current target direction. For example, node A may determine an azimuth correction value by computing a weighted combination of the primary azimuth deviation and the secondary azimuth deviation. In some embodiments, the primary azimuth deviation may be weighted more heavily in the weighted combination than the secondary azimuth deviation. An elevation correction value may be similarly computed based on a weighted combination of a primary elevation deviation and a secondary elevation deviation. Node A may correct the target direction of its lens (or lenses) based on the azimuth and elevation correction values, by appropriately controlling its motors.

In some embodiments, the computed azimuth correction value is applied to correct the azimuth component of the target direction only if the azimuth correction value is larger than a given threshold (e.g., a software-programmable threshold). Similarly, the computed elevation correction value is applied to correct the elevation component of the target direction only if the elevation correction value is larger than a given threshold (e.g., a software-programmable threshold). In some embodiments, this sensitivity-threshold mechanism is used to adjust system speed as a function of laser profile. Narrower beams typically require smaller values of the threshold.

After correcting its target direction, node A may pass a control token to node B, whereupon node B may perform the above-described method with roles reversed: node B drives the pointing direction of its lens/lenses through a path around its current target direction; node A collects received signal strength information and sends that information to node B; node B computes its primary estimates and secondary estimates; node B corrects its target direction based on a combination of the primary estimates and secondary estimates.

In some embodiments, node A adjust its motors to return the lens pointing direction from a final point of the path to the corrected target direction before passing control to node B.

By cycling back and forth between the two nodes, the pointing directions of the two nodes converge toward and maintain proper alignment in spite of movements of the structures on which the lenses are mounted.

The control token may be passed back and forth between the nodes as a mechanism for controlling which node at any given time takes which role.

Each node may repeat the lens-movement-and-direction-correction process, e.g., periodically, in order to maintain proper pointing alignment with the other node. The rate of repetition may be software adjustable. The rate of repetition may be determined by the amount or magnitude of adjustments required to maintain tracking.

In some embodiments, the above-described tracking mechanism may be implemented at least partially using one or more programmable hardware elements (e.g., one or more FPGAs) at each node. Such implementations may be able to operate at higher repetition rates than software-based implementations and may be needed in situations where at least one of the two nodes is mounted on an unstable structure (such as a pole or cell tower).

In some embodiments, the same methods that are used for tracking are used for initial alignment. The scanning/movement may follow a predetermined pattern in search of receive signal. The pattern starts in a coarse pattern and becomes higher resolution with following alignment scans. Once communication is established with remote side, the scans can be coordinated and remotely-acquired data can be used to determine movement to optimize alignment.

In various embodiments, the above-described tracking mechanism may be instrumental in ensuring that the optical data link between the nodes is reliable and of high quality (e.g., low bit error rate).

In some embodiments, each node may be configured to reduce cost by: 1) using a single transmitter and single receiver; and/or 2) removal of the 3rd motor and associated electronics.

When the optical wireless system is placed/mounted on an unstable structure, the optical tracking system may need to be agile. To account for 10 Hz movements, the optical tracking system may need to operate in excess of 20 Hz. The optical tracking system described herein can be implemented in software to track slow-moving structures like buildings. However, for cell towers, the system may be configured to operate in excess of the 20 Hz rate and may be implemented in hardware.

The present disclosure describes, among other things, a low-cost, tracking concept and mechanism to establish reliable communications in a free-space optical system even while deployed on unstable structures.

The present disclosure describes, among other things, a low-cost system, apparatus and method to enable narrow-beam optical wireless communications systems to maintain alignment via active tracking (For example, in one embodiment, the active tracking mechanism maintains alignment at distances of up to 3 km. However, other embodiments, accommodating other distance limits, are contemplated just as well.) In one embodiment, an optical wireless communication system configured with the presently-disclosed active tracking mechanism may enable reliable transmission of wireless signals at data rates of up to 2.5 Gbps.

The two ends of the link, near and remote, may work synchronously to maintain alignment. The near-end transmitter may generate a tracking signal on top of the data signal. In one embodiment, the data is comprised of non-return to zero (NRZ) modulation (e.g., at Gigabit Ethernet speeds of 1.25 Gbps). The tracking signal may be generated spatially with two stepper motors that move the transmitted optical beam in a scan (e.g., a rectangular scan). The remote receiver may use the tracking signal to measure the angular pointing error of the near-end. The remote receiver may communicate the angular pointing error to the near end so the near end may make azimuth and/or elevation corrections. The near-end receiver may simultaneously determine another angular point error based on measurements of the strength of the optical signal received from the far-end transmitter, i.e., measurements obtained while the near end is performing its scan. Thus, another source of angular error is available to the near end should there be failure in communications. The near end may use the two sources of angular error to control its motors and maintain alignment. The control/token may then be transferred to the far end, which repeats the process described above, thus maintaining alignment between the two ends.

The optical wireless communication system may be configured to operate at any of a wide variety of data rates. Increasing the bandwidth of the optical transmitter and receiver may be used to increase the data rate.

The optical wireless communication system may be configured to operate at any of a wide variety of wavelengths or wavelength ranges. The transmitter/receiver materials and processes may be altered to operate at different wavelength or wavelength ranges.

In one embodiment, the optical communication system allows transmission of Gigabit Ethernet signals operating at 1.25 Gbps data rate at any wavelength.

The power can be increased with higher slope efficiency, amplification, or by cooling the laser.

In conclusion, it is possible to operate the optical wireless communication system at various wavelengths, various power levels, and various data rates while maintaining the same basic tracking system.

In some embodiments, an optical wireless broadband system uses mechanical scanning as described herein to sense angular errors and achieve active tracking between two communications nodes.

In some embodiments, an optical tracking system uses bi-static radar principles as described herein to determine angular tracking errors, where the transmitter errors are sensed at the remote receiver and communicated back over the optical channel.

In some embodiments, an optical system uses mechanical scanning and bi-static radar concepts as described herein to track with either one lens using wavelength-division multiplexing (WDM) or two lenses to achieve low-cost wireless communications.

In some embodiments, the tracking system may be implemented in software. Such an implementation may be used in situations where the two nodes are subject to slower movements, e.g., movements that occur when the nodes are deployed on buildings.

In some embodiments, a high-speed tracking system may be implemented in hardware, to achieve fast active tracking on unstable structures.

In some embodiments, the scan is rectangular, where only one motor is active at a time, to minimize power consumption.

In some embodiments, each node separates the scanning mechanism and the tracking mechanism, e.g., by using stepper motors for movement only and adding a 3rd motor to perform the scanning and error measurement function. In other words, the stepper motors may be used to make adjustments to the target direction while the 3rd motor is used to scan the pointing direction around the target direction. Because the scanning mechanism and tracking mechanism are separated, both the near side and far side may scan simultaneously and continuously (and thus, make adjustments to their target directions simultaneously and continuously). Thus, the near side and far side need not alternate back and forth (take turns) in performing the scanning process.

In some embodiments, tracking performance may be optimized for different laser profiles by adjusting one or more algorithmic parameters, e.g., parameters such as RSSI threshold for each movement step, near/far weight, and scan size.

In some embodiments, the tracking system may be configured to compensate for collimation errors in multiple lens systems.

In some embodiments, the tracking system is configured to use only near-side scan data to obtain coarse alignment to obtain communications between systems thereby enabling the mutual-adaptive tracking algorithm to take over.

### BRIEF DESCRIPTION OF THE DRAWINGS

A better understanding of the present invention can be obtained when the following detailed description of the preferred embodiments is considered in conjunction with the following drawings.

FIG. 1 illustrates one embodiment of a optical communication system 100 configured to make adjustments to a target direction TD of its transmitted beam based on received signal strength information acquired by the remote optical communication system 160.

FIG. 2 illustrates an example of a path used to scan the pointing direction PD of the system 100.

FIG. 3 illustrates one embodiment of the optical communication system 100 including a terminal unit TU.

FIG. 4 illustrates one embodiment of the optical communication system 100 including a network interface 112.

FIG. 5 illustrates one embodiment of the optical communication system 100 including an optical fiber OF₁ to couple between the transmitter 110 and the lens L₁ (or lens unit or lens cell).

FIGS. 6A-C illustrate one embodiment of a mechanism for changing the pointing direction PD of the transmitted optical beam by translating the optical fiber OF₁.

FIGS. 7A-C illustrate one embodiment of a mechanism for changing the pointing direction PD of the transmitted optical beam by adjusting an angle of the optical fiber OF₁.

FIG. 8 illustrates one embodiment of the optical communication system 100 configured to transmit and receive through a single lens L₁.

FIG. 9 illustrates one embodiment of the optical communication system 100 where the transmitter, receiver and control unit are housed in a terminal unit TU.

FIG. 10 illustrates one embodiment of the optical communication system 100 including a network interface 112B.

FIG. 11 illustrates one embodiment of the optical communication system 100 where the transmitter and receiver couple to the lens L₁ through two separate optical fibers.

FIG. 12 illustrates one embodiment of the optical communication system 100 where a single optical fiber is used to convey the transmitted optical signal and the received optical signal.

FIG. 13 illustrates one embodiment of the optical communication system 100 including two lenses L₁ and L₂, one for transmission and the other for reception.

FIG. 14 illustrates one embodiment of the optical communication system 100 including a terminal unit TU and the two-lens configuration of the lens unit 120.

FIG. 15 illustrates one embodiment of the optical communication system 100 including the network interface 112B and the two-lens configuration of the lens unit.

FIG. 16 illustrates one embodiment of the optical communication system 100 including separate optical fibers for transmission and reception.

FIG. 17 illustrates one embodiment of a method for tracking a remote optical communication system based on received signal strength information supplied by the remote optical communication system.

FIG. 18 illustrates one embodiment of an optical communication system 1800 configured to make adjustments to a target direction of its lens unit 1810 based on measurements of the strength of the received optical signal 1815 while scanning a pointing direction of the lens unit around the target direction.

FIG. 19 illustrates an example of a path used to scan the pointing direction of lens unit 1810.

FIG. 20 illustrates one embodiment of the optical communication system 1800 including a terminal unit TU that houses at least the receiver 1840 and the control unit 1830.

FIG. 21 illustrates one embodiment of the optical communication system 1800 configured to transmit and receive through a single lens 1811.

FIG. 22 illustrates one embodiment of the optical communication system 1800 including the two-lens configuration of the lens unit 1810.

FIG. 23 illustrates one embodiment of a method for tracking a remote optical communication system based on measurements of the signal strength of an optical signal received from the remote optical communication system.

FIG. 24 illustrates one embodiment of an optical communication system 2400 configured to measure the strength of a received optical signal and to transmit those measurements to the remote optical communication system 2460.

FIG. 25 illustrates one embodiment of the optical communication system 2400 where at least the transmitter 2410, receiver 2420 and control unit 2440 are housed in a terminal unit.

FIG. 26 illustrates one embodiment of a method 2600 for making measurements of the signal strength of a signal received from a remote optical communication system and transmitting those measurements back to the remote optical communication system.

FIG. 27 illustrates an example of an application scenario where the optical communication nodes A and B are situated on the tops of buildings.

FIG. 28 illustrates an example of an application scenario where one of the communication nodes is situation on an unstable structure such as a pole (or cell tower).

FIG. 29 illustrates an example of an application scenario where nodes A and B each use a lens unit having two lenses.

FIG. 30 illustrates an example of an application scenario where node A uses a lens unit having a single lens while node B uses a lens unit having two lenses.

FIG. 31 shows one embodiment of the optical communication including a near end 3105 and a far end 3110.

FIG. 32 shows one embodiment of the communication service terminal (CST).

FIG. 33 shows one embodiment of the outdoor lens unit (OLU).

FIG. 34 shows one embodiment of the interconnect cables (ICC).

FIG. 35 shows one embodiment of a transmitter beam profile in 3D.

FIG. 36 shows one embodiment of a rectangular scan used to derive an error function.

FIGS. 37A and 37B show near side and far side RSSI patterns generated in response to a near side scan. (RSSI is an acronym for “received signal strength indicator”.)

FIG. 38 shows the near side RSSI measurement versus azimuth and elevation angles is flat across most of the beam.

FIG. 39 shows the near side tracking model areas of convergence using near side tracking error is insufficient to converge on the center of the beam.

FIG. 40 shows one embodiment of the far side RSSI is Gaussian when the transmitter scans across all azimuth and elevation angles.

FIG. 41 shows the far side RSSI tracking error is sufficient to converge to the center of the beam.

FIG. 42A shows one embodiment of a tracking algorithm that makes angular adjustments based on a weighted combination of near side error information and far side error information.

FIG. 42B shows one embodiment of an alternative tracking algorithm that selects near side measurement data or far side measurement data based on a slope comparison.

FIG. 42C illustrates an error function according to one embodiment of the tracking method.

FIG. 43 shows the one embodiment of a tracking handshake process to ensure reliable communications between the near side (node 1) and far side (node 2)

FIG. 44 shows that in one embodiment the system is able to reliably track on buildings.

FIG. 45 shows the near side and far side RSSI with a near side scan.

FIG. 46 shows the error free regions of operation with and without FEC.

FIG. 47 illustrates examples of possible scanning patterns.

FIG. 48 illustrates an example of active tracking with a two-lens system.

FIG. 49 illustrates an example of active tracking with a single lens system using wavelength-division multiplexing (WDM).

FIG. 50 illustrates one embodiment, where a 3^{rd} motor is used to perform scanning function.

FIG. 51 illustrates an embodiment of the 3^{rd} motor concept where the main motors are used for position correction only.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporations by Reference

The following patents are hereby incorporated by reference in their entireties.

U.S. Pat. No. 5,786,923, issued on Jul. 28, 1998, entitled “Point-To-Multipoint Wide Area Telecommunications Network Via Atmospheric Laser Transmission through a Remote Optical Router”.

U.S. Pat. No. 6,348,986, issued on Feb. 19, 2002, entitled “Wireless Fiber-Coupled Telecommunication Systems Based on Atmospheric Transmission of Laser Signals”.

U.S. Pat. No. 6,931,183, issued on Aug. 16, 2005, entitled “Hybrid Electro-Optic Cable for Free Space Laser Antennas”.

### Terminology

The following is a glossary of terms used in the present document.

Memory Medium—A memory medium is a medium configured for the storage and retrieval of information. Examples of memory media include: various kinds of semiconductor memory such as RAM and ROM; various kinds of magnetic media such as magnetic disk, tape, strip, film, etc.; various kinds of optical media such as CD-ROM and DVD-ROM; various media based on the storage of electrical charge and/or other physical quantities; media fabricated using various lithographic techniques; etc. The term “memory medium” includes within its scope of meaning the possibility that a memory medium may include a set of two or more memory media which reside at different locations, e.g., at different computers that are connected over a network.

Programmable Hardware Element—a hardware device that includes multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Program—the term “program” is intended to have the full breadth of its ordinary meaning. As used herein, the term “program” includes within its scope of meaning: 1) a software program which is stored in a memory and is executable by a processor, or, 2) a hardware configuration program useable for configuring a programmable hardware element. Any of the method embodiments described herein, or, any combination of the method embodiments described herein, or, any subset of any of the method embodiments described herein, or, any combination of such subsets may be implemented in terms of one or more programs.

Software Program—the term “software program” is intended to have the full breadth of its ordinary meaning, and includes any type of program instructions, code, script and/or data, or combinations thereof, that may be stored in a memory medium and executed by a processor or computer system. Exemplary software programs include: programs written in text-based programming languages such as C, C++, Java™, Pascal, Fortran, Perl, etc.; programs written in graphical programming languages; assembly language programs; programs that have been compiled to machine language; scripts; and other types of executable software. A software program may comprise two or more subprograms that interoperate in a specified manner.

Hardware Configuration Program—a program, e.g., a netlist or bit file, that can be used to program or configure a programmable hardware element.

Computer System—any of various types of computing or processing systems, including a personal computer (PC), a mainframe computer system, a workstation, a laptop, a tablet computer, a network appliance, an Internet appliance, a hand-held or mobile device, a personal digital assistant (PDA), a television system, a grid computing system, or other device or combinations of devices. In general, the term “computer system” can be broadly defined to encompass any device (or combination of devices) having at least one processor that is configured to execute program instructions that are stored on a memory medium.

A computer-readable memory medium is a memory medium that stores program instructions, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a computer system may include a processor (or a set of processors) and a memory medium. The memory medium stores program instructions. The processor is configured to read and execute the program instructions from the memory medium. The program instructions are executable by the processor to implement a method, e.g., any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a mobile device, a tablet computer, a wearable computer, a computer integrated in a head-mounted display, etc.

In some embodiments, a set of computers distributed across a computer network may be configured to partition the effort of executing a computational method (e.g., any of the method embodiments disclosed herein).

Local Node Adjusts Target Direction Based on Signal Strength Feedback

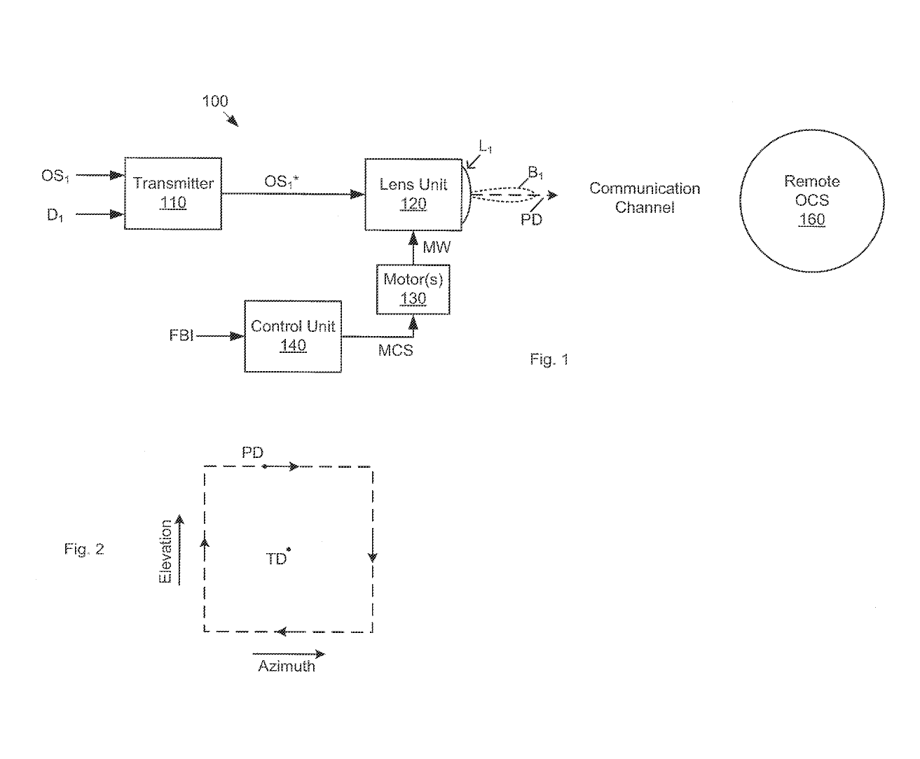

In one set of embodiments, an optical communication system 100 may be configured as shown in FIG. 1. The optical communication system 100 may include a transmitter 110, a lens unit 120, a set 130 of one or more motors, and a control unit 140. (Furthermore, the optical communication system 100 may include any subset of the features, embodiments and elements described below in connection with system 1800, system 2400 and system 3100.)

The transmitter 110 may be configured to modulate a data stream D₁ onto an optical signal OS₁ to obtain a modulated optical signal OS₁*. The optical signal OS₁ may be generated by a laser device. In some embodiments, the optical communication system 100 includes only a single laser device. In some embodiments, the laser device is a multimode laser, and the optical signal OS₁ is a multimode optical signal.

The lens unit 120 includes at least a lens L₁. The lens L₁ may be configured to transmit the modulated optical signal OS₁* into space as a beam B₁. In other words, the transmitted optical energy is concentrated according to a directed spatial pattern.

The one or more motors 130 may be configured to adjust a pointing direction PD of the lens L₁ (or the lens unit 120 or the beam B₁). The one or motors 130 may perform mechanical work MW on the lens unit 120 (or the lens L₁, or an optical fiber that supplies light to the lens L₁, or some other component of the lens unit 120) in order to adjust the pointing direction PD. Various options will be discussed hereafter.

The control unit 140 may be configured to control the one or more motors 130 so as to move the pointing direction PD of the lens L₁ through a path centered on (or, specified relative to, or, surrounding) a current target direction TD. For example, the pointing direction PD may trace a rectangular path around the target direction TD as shown in FIG. 2. (However, it should be understood that the present inventions are not limited to any particular path geometry.) The path may be expressed as a path in azimuth-elevation space. The azimuth and elevation may be defined relative to an origin at the lens unit 120. (It should be understood that the present inventions are not limited by any particular choice for coordinate system.).

The control unit 140 may generate one or more motor control signals MCS to control the one or more motors 130. In some embodiments, the one or more motors are stepper motors.

In one embodiment, there are two motors, e.g., one for azimuth adjustment and one for elevation adjustment of the beam B₁.

The control unit 140 may be configured to receive feedback information FBI generated by a remote optical communication system (OCS) 160. In different embodiments, the feedback information may be received in different ways. (For example, the remote optical communication system may transmit an optical signal containing the feedback information. That optical signal may be received and demodulated by the optical communication system 100. In an alternative embodiment, the remote optical communication may transmit a radio signal including the feedback information; the optical communication system 100 may receive and demodulate the radio signal.)

The feedback information includes (or is based on) measurements of strength of the beam B₁ (or the optical signal OS₁*) as received by the remote optical communication system 160 during the movement of the pointing direction PD of the lens L₁ through the path. The control unit 140 may be configured to control the one or more motors 130 so as to adjust the target direction TD of the lens L₁ based on a data set including the feedback information. (In some embodiments, the data set may include addition information, as described further below.) The adjustment may bring the target direction TD closer to being pointed exactly at the remote optical communication system 160 or at a receiving lens of the remote optical communication system.

In some embodiments, the transmitter 110 may be configured to perform forward error correction (FEC) encoding on the data stream D₁ prior to modulating the data stream D₁ onto the optical signal OS₁. Thus, the transmitter may include digital circuitry to perform the FEC encoding. Any of a wide variety of conventional methods may be employed to perform the FEC encoding.

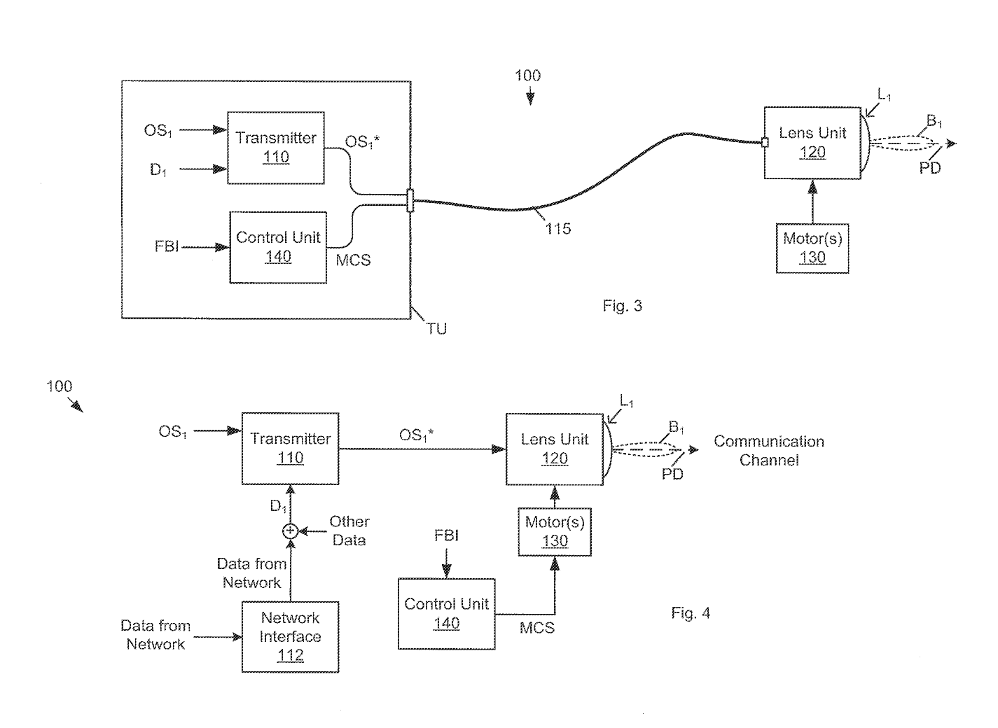

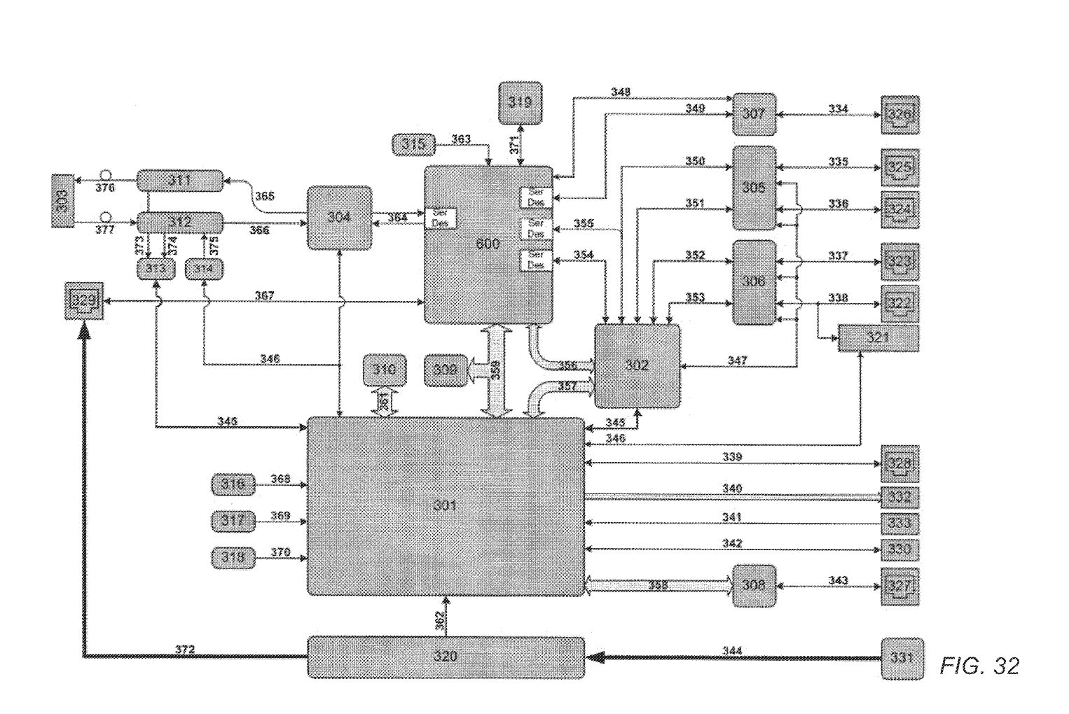

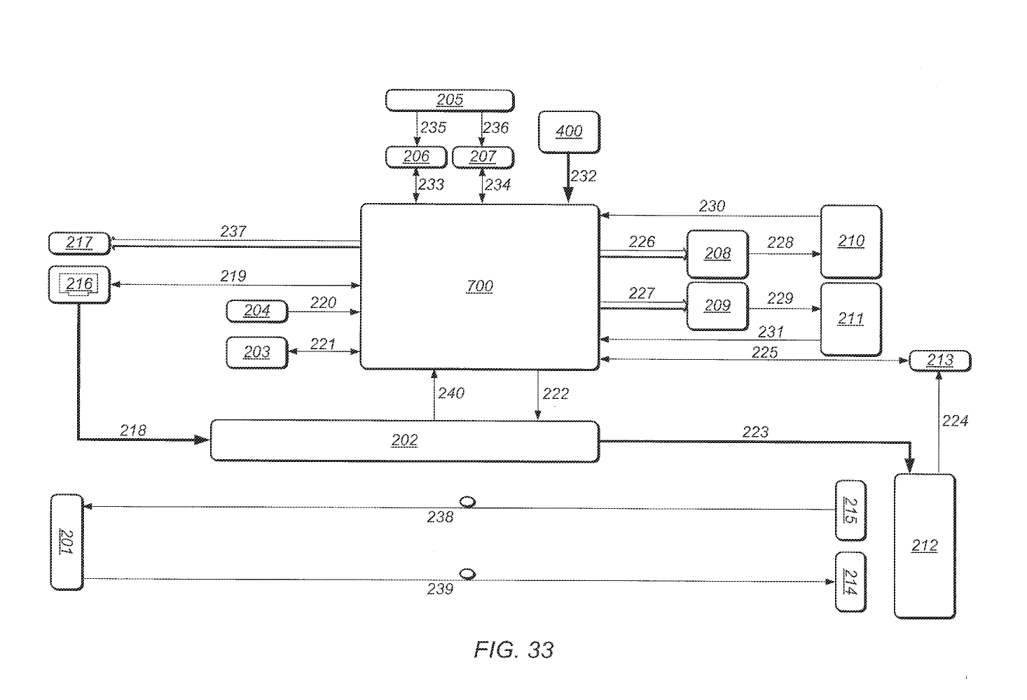

In some embodiments, the transmitter 110 and at least a portion of the control unit 140 may be incorporated in a terminal unit TU, e.g., as shown in FIG. 3. (The relative sizes of elements, the relative positions of elements, and the distances between elements shown in the figures are not meant to be limiting, and are not necessarily representative of the relative sizes, relative positions and distances used in actual implementations. Rather, the figures are generally meant to illustrate the conceptual flow and architecture of processing being performed.) FIG. 3 shows the example where the entirety of the control unit 140 is located in the terminal unit. However, in some embodiments, the control unit 140 may be divided into two parts, one part residing in the terminal unit TU and the other part residing in the lens unit 120. For example, referring to FIGS. 32 and 33, processor 301 and FPGA 700 may be interpreted as different parts of the control unit 140. The processor 301 resides in communication services terminal 3300 while FPGA 700 reside in outdoor lens unit 3200.

The terminal unit TU may be configured for coupling to the lens unit 120 via one or more cables. The terminal unit TU may be configured to supply the modulated optical signal OS₁* to the lens unit 120 through the one or more cables, e.g., through an optical fiber included in one of the cables. Furthermore, the terminal unit TU may be configured to send the motor control signals MCS to the lens unit (destined for the one or more motors 130) through the one or more cables. FIG. 3 shows the example of a single cable, i.e., cable 115, that carries both the modulated optical signal OS₁* and the motor control signals MCS.

The lens unit 120 is preferably configured for outdoor operation. In some embodiments, the lens unit 120 includes (or, is contained within) a rain-proof enclosure. Furthermore, the enclosure may be ruggedized, capable of withstanding environmental factors such as hail impact, strong winds, high and/or low temperatures, or any combination of such factors.

In some embodiments, the terminal unit TU may be also be configured to supply power to the lens unit 120 through the one or more cables, e.g., through a pair of electrical conductors included in one of the cables. The lens unit 120 may include electronic circuitry, and thus, may require electrical power to drive the circuitry.

In some embodiments, the lens unit 120 includes a heating element for heating the lens L₁ in order to prevent condensation from accumulating on the surface(s) of the lens L₁. The control unit 140 may turn on the heating element at times when the accumulation of condensation is possible or probable. The control unit 140 may monitor measurements of temperature and/or humidity of the external environment to determine when to turn on the heating element. (See the discussion below of the sensor module 205.)

In some embodiments, the optical communication system 100 may also include a network interface 112, e.g., as shown in FIG. 4. The network interface may be configured to receive data from an external network and to inject the data into the data stream D₁ so that the data may be modulated onto the optical signal OS₁. (The “+” node in FIG. 4 is meant to suggest any sort of combining or concatenation or intermixing of data.) In various different embodiments, the network interface may be configured to interface with various different communication media, using various different communication and/or signaling protocols. (In one embodiment, the network interface is an Ethernet interface.) The network interface may be included in the terminal unit TU.

In some embodiments, the network interface 112 may be configured to support a plurality of network clients simultaneously, e.g., as described below in connection with FIG. 32. Thus, the data received from the external network may include data from each of the network clients.

In some embodiments, the network interface 112 includes one or more ports for interfacing with the external network, where one or more of the ports are configured to convey power (from the optical communication system 100) as well as data. The conveyed power may be used to power external devices, e.g., devices such as one or more radios of any of various kinds and/or one or more of the network clients. The external network may be an Ethernet network, and the ports may be configured to conform with the Power Over Ethernet (PoE) Standard. In one application scenario, a wireless hot spot may couple to the optical communication system 100 through one of the ports, and receive power from the optical communication system 100 through the port. Wireless-enabled computers in the vicinity of the hot spot transmit their data to the hot spot. The hot spot sends that data to the optical communication system 100 through the port, and the data is then sent over the optical link to the remote optical communication system 160. Similarly, data from the remote optical communication system 160 is sent over the optical link to the optical communication system 100, sent to the hot spot through the port, and then transmitted by the hot spot to the wireless-enabled computers.

In some embodiments, the transmitter 110, the lens unit 120 and the control unit 140 are incorporated into a single integrated unit, e.g., housed in a single chassis or package. In one embodiment, the one or more motors may also be included in the single integrated unit.

In some embodiments, the feedback information FBI may include the strength measurements (i.e., the measurements of strength of the beam B₁ as received by the remote optical communication system 160 during the movement of the pointing direction PD of the lens L₁ through the path.) Alternatively, the feedback information FBI may include angular error information derived from the strength measurements, e.g., as described below in connection with system 3100. The angular error information indicates how the optical communication system 100 should adjust (or correct) the target direction TD in order to more closely approach the ideal target direction. The ideal target direction may be interpreted as the direction that makes the beam B₁ point exactly at the receiver antenna (receiver lens) of the remote optical communication system 160.

It is not necessary to wait until the movement of the pointing direction PD through the path has completed in order to receive the feedback information FBI and make an adjustment to the target direction. Indeed, in some embodiments, the control unit 140 is configured to receive portions of the feedback information FBI during the path movement of the pointing direction through the path, and to make corresponding adjustments to the target direction during the movement of the pointing direction through the path. For example, the remote optical communication system 160 may send updated azimuth and elevation error information upon completing each quadrant of the path. The control unit 140 may receive this updated information per quadrant and make a corresponding adjustment to the target direction per quadrant. Thus, the tracking algorithm can converge much faster than if directional adjustment were postponed until after completion of the whole path movement. The remote optical communication system may compute each update of the azimuth and elevation error information based on the strength measurements for the just completed quadrant and the other three quadrants. If one or more of the other three quadrants have not yet been visited in the present movement of the pointing direction, the strength measurements from a previous path movement (previous traversal of the path) may be used for those quadrants.

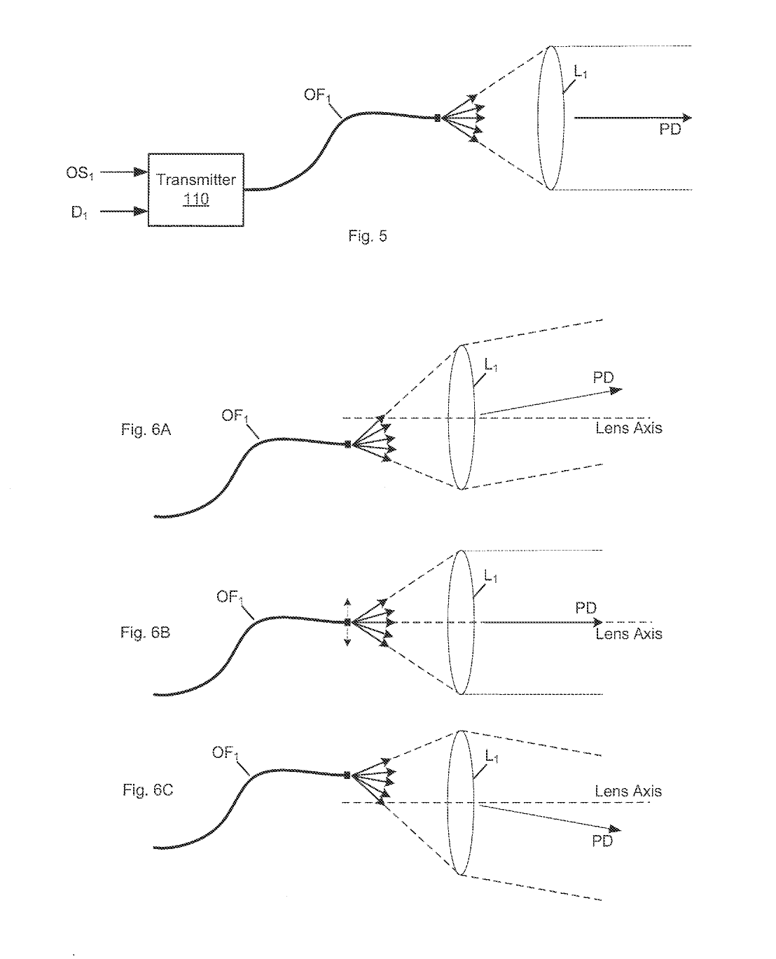

In some embodiments, the optical communication system 100 may include an optical fiber OF₁ which is configured to convey the modulated optical signal OS₁* from the transmitter to the lens L₁, e.g., as illustrated in FIG. 5. The optical fiber OF₁ may be included in one of the one or more cables described above.

In some embodiments, the one or more motors 130 may be configured to adjust the pointing direction PD of the lens L₁ by translating an end of the optical fiber OF₁ relative to the lens L₁, e.g., as shown in FIGS. 6A-6C. The end of the optical fiber OF₁ may be translated along a line (or over a two-dimensional region) perpendicular to the axis of the lens L₁. For example, in FIG. 6B, the end of the optical fiber OF₁ is situated near a focal point of the lens L₁. Thus, the pointing direction PD lines up with the lens axis. In FIG. 6A, the end of the optical fiber OF₁ has been translated downward relative to the lens axis. Thus, the pointing direction PD has an upward incline. In FIG. 6C, the end of the optical filter has been translated upward relative to the lens axis. Thus, the pointing direction PD has a downward incline. In some embodiments, one motor may be used to translate the fiber end along one dimension (e.g., up and down in the figure) and another motor may be used to translate the fiber end along another dimension, both dimensions being perpendicular to the lens axis.

In some embodiments, the fiber end may also be translated along the lens axis, thus enabling control of the transmitted beam width.

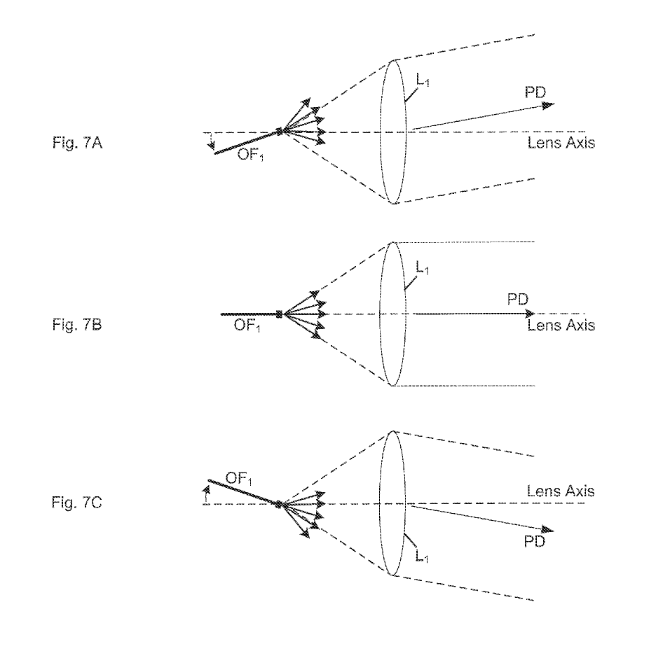

In some embodiments, the one or more motors 130 may be configured to adjust the pointing direction PD of the lens L₁ by adjusting an angle of the end of the optical fiber OF₁ relative to the axis of the lens L₁, e.g., as shown in FIGS. 7A-7C.

As described above, the lens L₁ transmits the modulated optical signal OS₁* into space as a beam B₁. In some embodiments, the lens L₁ is configured so that the beam B₁ has a Gaussian transmission pattern. However, the present inventions are not limited to any one type of pattern.

In some embodiments, the one or more motors 130 may be configured to adjust the pointing direction PD by adjusting an angular orientation of the lens unit 120. For example, the one or more motors may include one motor configured to adjust an azimuth angle of the lens unit and a second motor configured to adjust an elevation angle of the lens unit.

The control unit 140 may realized in any of a wide variety of forms. For example, the control unit may be realized by one or more processors (which are configured to execute program instructions), by one or more custom-designed digital devices (such as application specific integrated circuits ASICs), by one or more programmable hardware elements (such as FPGAs), or by any combination of the foregoing types of devices.

In embodiments targeted for high-speed tracking, the control unit 140 preferably includes at least one programmable hardware element.

In some embodiments, the programmable hardware element is configured to buffer the data stream D₁ in a memory and to retransmit portions (e.g., packets) of the data stream D₁ in response to determining that the remote optical communication system has not acknowledged receipt of those portions. The retransmission includes re-modulating those portions onto the optical signal OS₁. When portions are acknowledged, the buffer space occupied by those packets may be released.

In some embodiments, the control unit 140 is configured to compute an azimuth error and/or elevation error based on the feedback information FBI. The action of adjusting the target direction TD of the lens L₁ may include adjusting an azimuth angle of the target direction based on the computed azimuth error, and/or, adjusting an elevation angle of the target direction based on the computed elevation error. In one embodiment, the azimuth angle may be adjusted only if the computed azimuth error is greater than an azimuth error threshold. Similarly, the elevation angle may be adjusted only if the computed elevation error is greater than an elevation error threshold. These thresholds may be programmable, e.g., by a host computer that couples to the optical communication system 100.

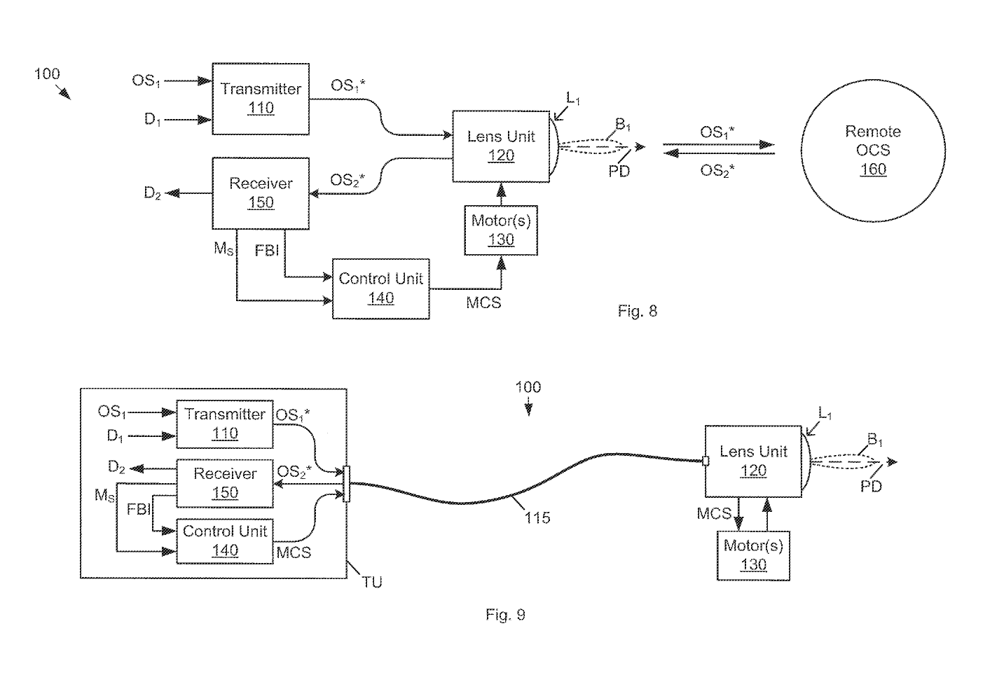

In some embodiments, the optical communication system 100 also includes a receiver 150, e.g., as shown in FIG. 8. The lens L₁ is configured to receive an optical signal OS₂* from space. The receiver 150 receives the optical signal OS₂* from the lens L₁, e.g., via an optical fiber. The optical signal OS₂* is transmitted from the remote optical communication system 160. (The optical signal OS₂* may be a modulated optical signal, i.e., an information-bearing optical signal.) The receiver 150 may be configured to recover a data stream D₂ from the optical signal OS₂*, and extract the feedback information FBI from the data stream D₂. The receiver may be further configured to capture measurements M_{L} of strength of the optical signal OS₂* during the movement of the pointing direction of the lens L₁ through the path.

In some embodiments, the receiver 150 includes an optical filter configured to filter the optical signal OS₂* prior to recovering the data stream D₂ from the optical signal OS₂*. The filter attenuates wavelength components in one or more noise-bearing wavelength bands. For example, the filter may be configured to attenuate external interference sources such as sunlight.

In some embodiments, the transmitter 110, the receiver 150 and at least a portion of the control unit 140 are incorporated in the terminal unit TU, e.g., as shown in FIG. 9. As described above, the terminal unit TU may be configured for coupling to the lens unit 120 via one or more cables. The terminal unit TU is configured to supply the modulated optical signal OS₁* to the lens unit 120 through the one or more cables. Furthermore, the lens unit is configured to supply the received optical signal OS₂* to the terminal unit TU through the one or more cables. FIG. 9 illustrates the case where a single cable, i.e., cable 115, conveys the optical signal OS: from the terminal unit to the lens unit, conveys the optical signal OS₂* from the lens unit to the terminal unit, and conveys the motor control signals MCS to the lens unit.)

In some embodiments, the one or more cables include a hybrid electro-optic cable, where the hybrid electro-optic cable includes two or more optical fibers and a plurality of electrical conductors. For more information, on how to make and use such hybrid electro-optic cables, please see U.S. Pat. No. 6,931,183, issued on Aug. 16, 2005, entitled “Hybrid Electro-Optic Cable for Free Space Laser Antennas”, which is hereby incorporated by reference in its entirety.

In some embodiments, the plurality of electrical conductors include a pair that is configured to convey power from the terminal unit TU to the lens unit 120. This conveyed power may be used by the lens unit 120 and/or the one or more motors 130. In some embodiments, this conveyed power may be the only source of power for the lens unit 120 and the one or more motors 130.

The terminal unit TU may receive its power from a building in which it situated.

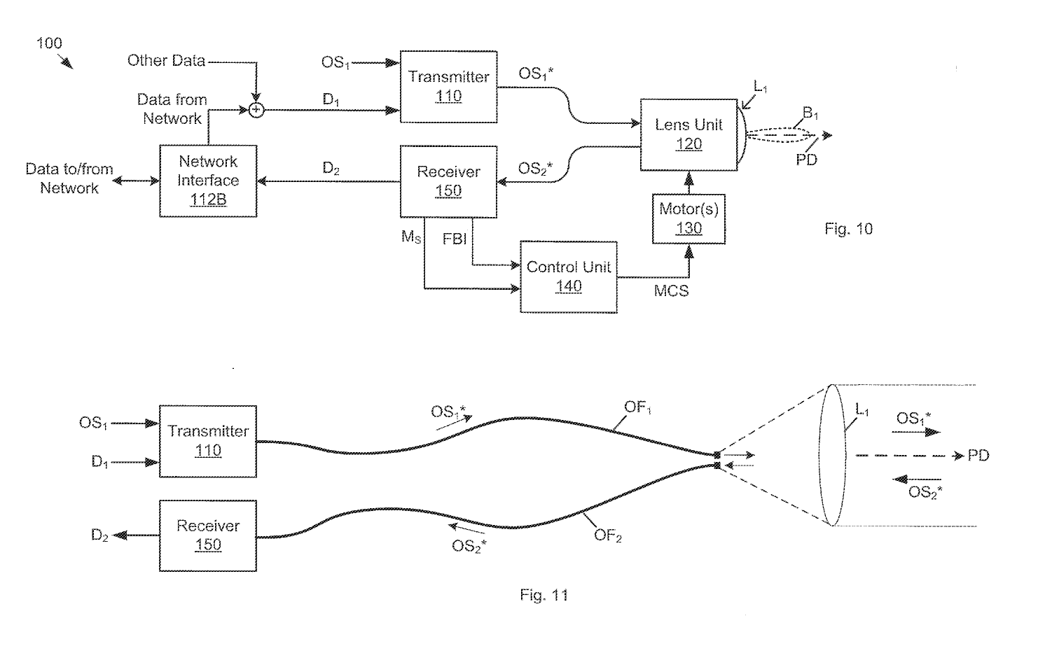

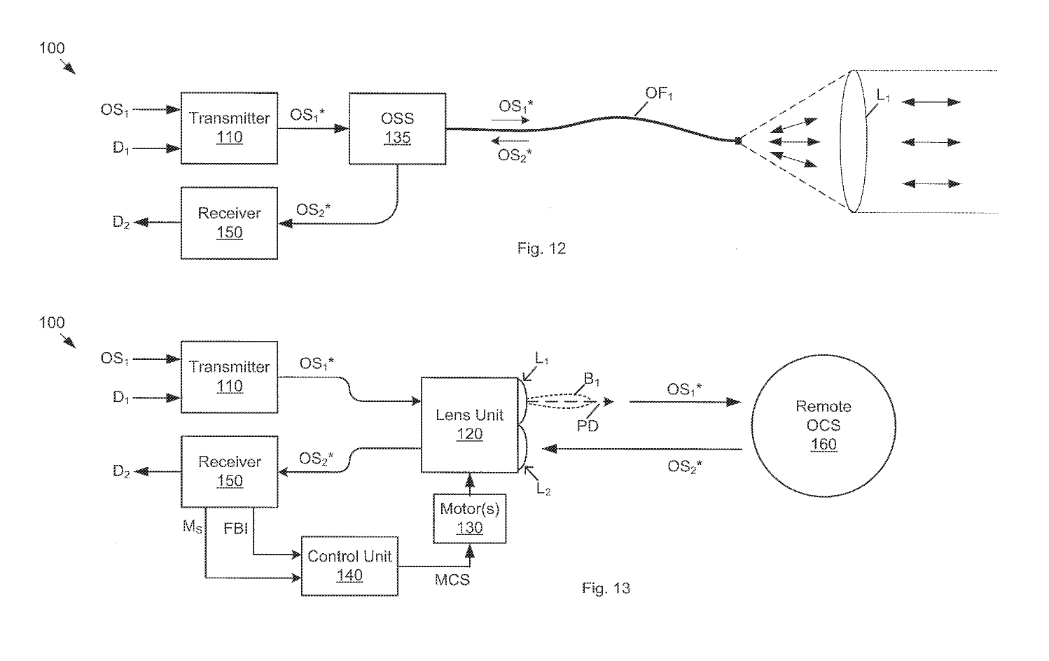

In some embodiments, the optical communication system 100 may also include a network interface 112B, e.g., as shown in FIG. 10. The network interface 112B may be configured to receive data packets from an external network and to inject the data packets into the data stream D₁. Furthermore, the network interface 112B may be configured to extract data packets from the data stream D₂ and to transmit the data packets onto the external network.

In some embodiments, the transmitter 110, the receiver 150, the lens unit 120, and the control unit 140 are incorporated into a single integrated package. In one embodiment, the one or more motors 130 are also included as part of the integrated package.

In some embodiments, the data set used by the control unit 140 to determine the adjustment to the target direction TD also includes the strength measurements M_{L} captured by the receiver 150. These measurements may be referred to as “locally captured measurements” as opposed to the measurements captured by the remote optical communication system. By computing the target direction adjustment based on a combination of the locally-captured measurements M_{L} and the feedback information FBI, the adjustments may be of higher quality, i.e., result in faster convergence or more accurate tracking than if only one source of information were used.

In some embodiments, the optical communication system 100 also includes optical fibers OF₁ and OF₂, e.g., as shown in FIG. 11. The optical fiber OF₁ may be configured to convey the modulated optical signal OS₂* from the transmitter 110 to the lens L₁; the optical fiber OF₂ may be configured to convey the optical signal OS; from the lens L₁ to the receiver 150. (An end of the optical fiber OF₁ and an end of the optical fiber OF₂ may be collocated at or near the focal point of the lens L₁.) In one embodiment, the optical fibers OF₁ and OF₂ may extend from a chassis of the terminal unit TU to the lens unit housing.

In some embodiments, the transmitter 110 and receiver 150 may employ a single optical fiber OF₁ to send the optical signal OS₁* to the lens L₁ and to receive the optical signal OS₂* from the lens L₁. An optical subsystem 135 may be used to inject the OS₁* onto the optical fiber and to extract the OS₂* from the optical fiber. The optical signals OS₁* and OS; may use different wavelengths or wavelength bands in order facilitate the injection and extraction.

In some embodiments, the control unit 140 is further configured to inject messages targeted for the remote optical communication system 160 into the data stream D₁. Each of the messages indicates a corresponding point (relative position) along the path. (A number of points along the path may be designated as waypoints.) The remote optical communication system 160 may be configured to recover the data stream D₁ from the optical signal OS₁*, and to synchronize its measurements of the strength of the beam B₁ with the reception of the messages. For example, each of the measurements may be captured when a corresponding one of the messages is received.

In some embodiments, the control unit 140 is configured to compute an angular error based on the feedback information and the locally-acquired strength measurements M_{L}. The control unit may also be configured to control the one or more motors 130 so as to adjust the target direction based on the angular error.

In some embodiments, the lens unit 120 may include a lens L₂ in addition to the lens L₁, e.g., as shown in FIG. 13. In these embodiments, the optical communication system 100 may employ the lens L₁ for transmission as described above (e.g., in connection with FIG. 1), and employ the lens L₂ for reception. The lens L₂ is configured to receive the optical signal OS₂* from space. (The optical signal OS₂* is transmitted from the remote optical communication system 160.) The receiver 150 is configured to recover the data stream D₂ from the optical signal OS₂*, and to extract the feedback information FBI from the data stream D₂. The receiver 150 is further configured to capture the measurements M_{L} of strength of the optical signal OS₂* during the movement of the pointing direction PD through the path.

The lenses L₁ and L₂ may be mounted in the lens unit 120 so that their optical axes are parallel.

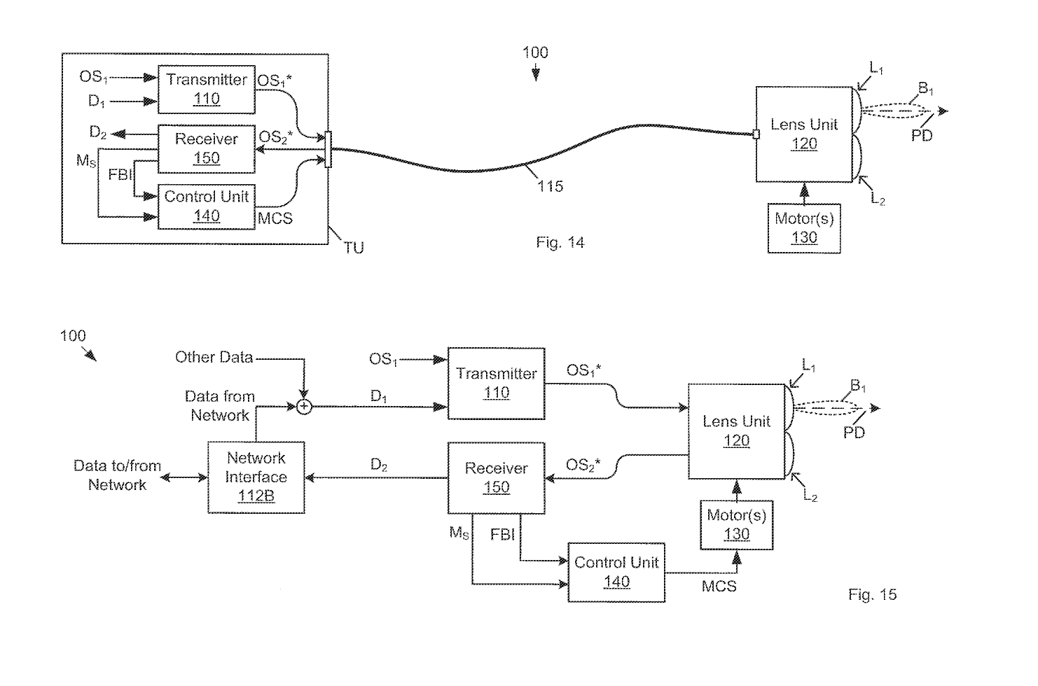

In some embodiments, the transmitter 110, the receiver 150 and at least a portion of the control unit 140 are incorporated in the terminal unit TU, e.g., as shown in FIG. 14. The terminal unit TU is configured for coupling to the lens unit 120 via one or more cables. The terminal unit TU is configured to supply the modulated optical signal OS₁* to the lens unit through the one or more cables. The lens unit supplies the modulated optical signal OS₁* to the lens L₁. Furthermore, the lens unit is configured to supply the optical signal OS₂* to the terminal unit through the one or more cables. Figure 14 shows the example where a single cable, i.e., cable 115, is used to connect the terminal unit and the lens unit.

In some embodiments, the one or more cables include a hybrid electro-optic cable. (The cable 115 may be a hybrid electro-optic cable.) The hybrid electro-optic cable includes two or more optical fibers and a plurality of electrical conductors. A first of the optical fibers may be used to convey the optical signal OS₁* from the terminal unit to the lens unit 120. A second of the optical fibers may be used to convey the optical signal OS₂* from the lens unit to the terminal unit. In some embodiments, the plurality of electrical conductors includes a first pair that is configured to convey power from the terminal unit to the lens unit. The conveyed power may be used to power circuitry in the lens unit and/or to power the one or more motors 130. In some embodiments, the plurality of electrical conductors may include a ground line and a data-carrying line.

As described above, the optical communication system 100 may include the network interface 112B. FIG. 15 shows one such embodiment, incorporating the two-lens version of the lens unit 120.

In some embodiments, the transmitter 110, the receiver 150, the control unit 140 and the two-lens version of the lens unit 120 may be incorporated into a single integrated package. In some embodiments, the one or more motors 130 are also included in the single integrated package.

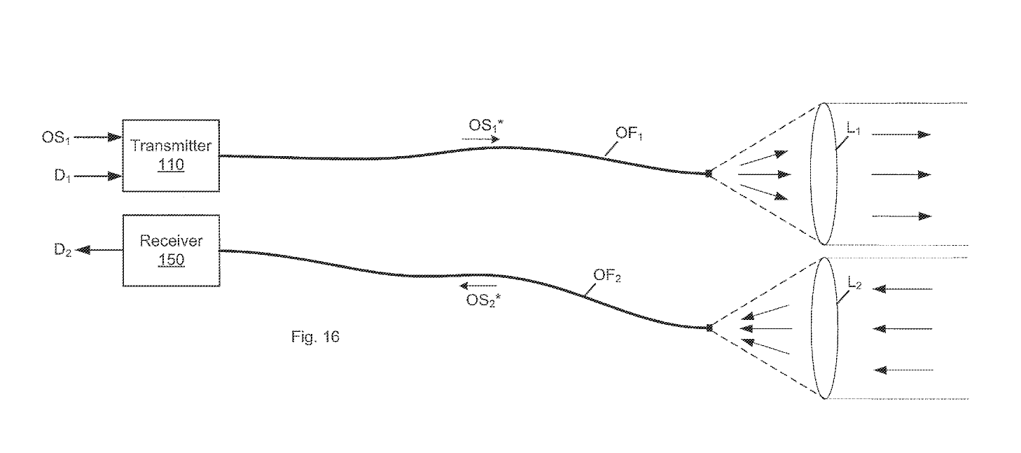

In some embodiments, the optical communication system 100 includes an optical fiber OF₁ configured to convey the modulated optical signal OS₁* from the transmitter 110 to the lens L₁, and an optical fiber OF₂ configured to convey the optical signal OS₂* from the lens L₂ to the receiver 150, e.g., as shown in FIG. 16.

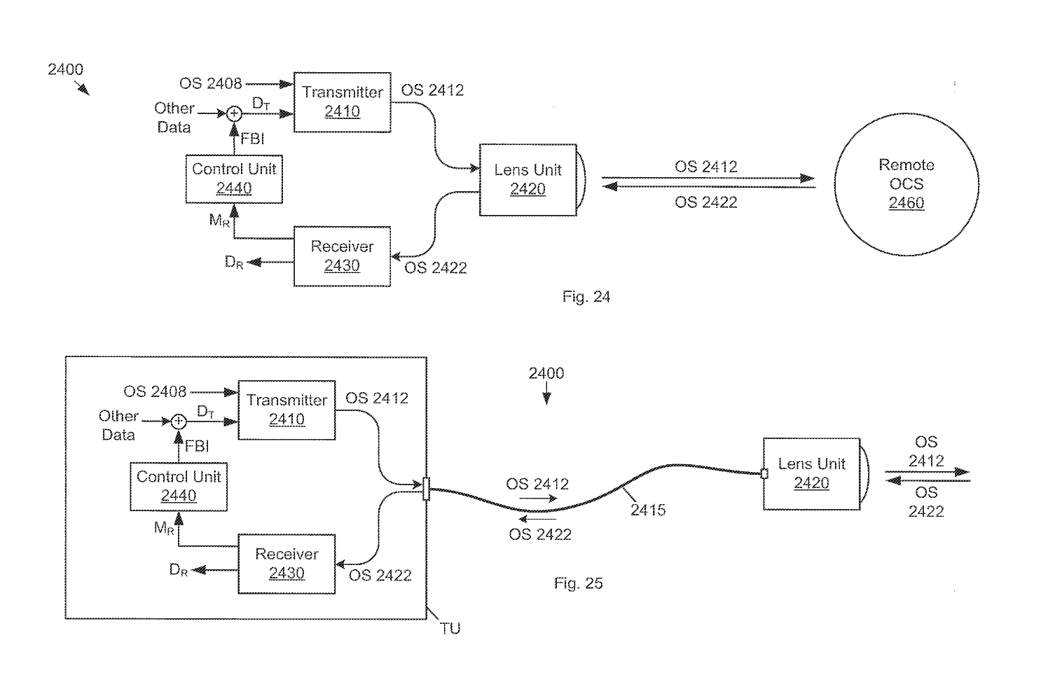

The remote optical communication system 160 may be configured as described below in connection with FIGS. 24-26.

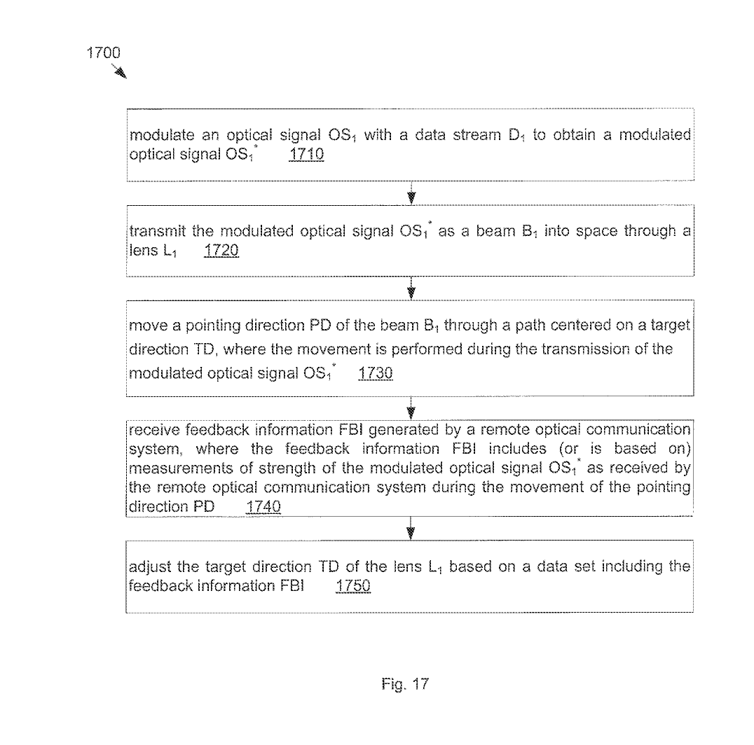

In one set of embodiments, a method 1700 for operating an optical communication system may include the operations shown in FIG. 17. (Furthermore, the method 1700 may include any subset of the features, embodiments, and operations described above.)

At 1710, an optical signal OS₁ is modulated with a data stream D₁ to obtain a modulated optical signal OS₁*. The modulation may be performed by the above-described transmitter 110 (in any of its various embodiments). Devices and methodologies for modulating optical signals with data streams are well known in the field of optical communication, and thus, need not be elaborated here.

At 1720, the modulated optical signal OS₁* is transmitted as a beam B₁ into space through a lens L₁, e.g., as variously described above. For example, the modulated optical signal OS₁* may be delivered from the transmitter to a focal point of the lens L₁ by an optical fiber. The light of the modulated optical signal OS₁* emanates from the end of the optical fiber and is transmitted into space by the lens L₁.

In some embodiments, or in some modes of operation, the action 1710 of modulating the optical signal OS₁ may be omitted. Thus, the action 1720 will involve transmitting the optical signal OS₁ instead of the modulated optical signal OS₁*.

At 1730, a pointing direction PD of the beam B₁ is moved through a path centered on a target direction TD, where the movement is performed during the transmission of the modulated optical signal OS₁*. The pointing direction PD may be moved as variously described above.

In some embodiments, the pointing direction PD and target direction TD may be represented as vectors in azimuth-elevation space:

PD=(AZ_{PD},EL_{PD})

TD=(AZ_{TD},EL_{TD})

PD=TD+(ΔAZ,ΔEL).

The pointing direction may be made to traverse a path around the target direction by driving the displacement vector (ΔAZ,ΔEL) through a corresponding path around the origin.

At 1740, feedback information FBI generated by a remote optical communication system is received. The feedback information FBI includes (or is based on) measurements M_{R} of strength of the modulated optical signal OS₁* as received by the remote optical communication system during the movement of the pointing direction PD. The feedback information may be received as variously described above.

At 1750, the target direction TD of the lens L₁ is adjusted based on a data set including the feedback information FBI, e.g., as variously described above. For example, an azimuth error and elevation error may be computed based on the data set, and then used to adjust the target direction:

TD←TD+(AzimuthError,ElevationError).

In some embodiments, the action of adjusting the target direction may be preceded by the action of moving the pointing direction PD to the current target direction TD:

PD←TD

TD←TD+(AzimuthError,ElevationError).

In some embodiments, the method 1700 also includes performing forward error correction (FEC) encoding on the data stream D₁ prior to said modulating.

In some embodiments, the action 1740 of receiving feedback information includes receiving portions of the feedback information during (e.g., throughout) the movement of the pointing direction through the path, and the action 1750 of adjusting the target direction TD includes making a plurality of adjustments to the target direction during (e.g., throughout) the movement of the pointing direction through the path, where each of the adjustments corresponds to a respective one of the portions.

In some embodiments, the method 1700 also includes: (a) receiving an optical signal OS₂ from space through the lens L₁, where the optical signal OS₂* is transmitted into space from the remote optical communication system; (b) recovering a data stream D₂ from the optical signal OS₂*, where the action of receiving the feedback information FBI includes extracting the feedback information FBI from the data stream D₂; and (c) capturing measurements M_{L} of signal strength of the optical signal OS₂^{*} during the movement of the pointing direction PD. The data set used to determine the adjustment of the target direction may include the captured measurements M_{L} in addition to the feedback information FBI. The optical signal OS₂* may be filtered in order to remove noise (i.e., interference). The filtering may be performed prior to the action of recovering the data stream D₂.

In alternative embodiments, the optical signal OS₂* is received from the space through a second lens (e.g., the lens L₂ as variously described above).

In some embodiments, the path is a rectangular path. The rectangular shape allows the path to be traversed by activating only one motor at a time. An azimuth-adjusting motor may rest while an elevation-adjust motor is activated, and vice versa. See FIG. 2.

In some embodiments, the method 1700 may also include sending a control token to the remote optical communication system to enable the remote optical communication system to initiate a process of moving a pointing direction of its transmitted beam and adjusting a target direction of its transmitted beam. (The optical communication system 100 may hold its pointing direction PD constant while the remote optical communication system 160 performs that process.)

In some embodiments, the set S_{OP} of operations including operations 1730, 1740 and 1750 may be repeated, e.g., at a rate that is programmable.

In some embodiments, the optical communication system and the remote communication system perform the set of operations S_{OP} alternately, e.g., by passing the control token back and forth between them.

In some embodiments, the method 1700 may also include computing an angular error (e.g., an azimuth error and/or an elevation error) based on the feedback information FBI. In some embodiments, the action 1750 of adjusting the target direction TD may be only if the angular error is greater than a predetermined threshold.

In some embodiments, the action 1730 of moving the pointing direction PD of the beam B₁ includes moving a pointing direction of a lens unit that contains the lens L₁. For example, the lens unit may be mounted on a platform that admits controllable rotations in azimuth and elevation. The one or more motors 130 may be included as part of the platform.

In some embodiments, the action 1730 of moving the pointing direction PD of the beam B₁ includes moving an end of an optical fiber relative to the lens L₁, e.g., as variously described above.

In some embodiments, the action of moving the end of the optical fiber relative to the lens L₁ includes translating the end of the optical fiber relative to the lens L₁.

In some embodiments, the action of moving the end of the optical fiber relative to the lens L₁ includes adjusting an angle of the end of the optical fiber relative to the lens L₁.

In some embodiments, the method 1700 may also include: buffering the data stream D₁ in a memory; and retransmitting portions of the data stream D₁ in response to determining that the remote optical communication system has not acknowledged receipt of those portions. The action of retransmitting includes re-modulating the optical signal OS₁ with those portions. The buffering and retransmitting may controlled by a programmable hardware element (e.g., an FPGA residing in the lens unit 120 and/or an FPGA residing in the terminal unit TU).

Adjusting Target Direction Based on Locally-Acquired Signal Strength Measurements

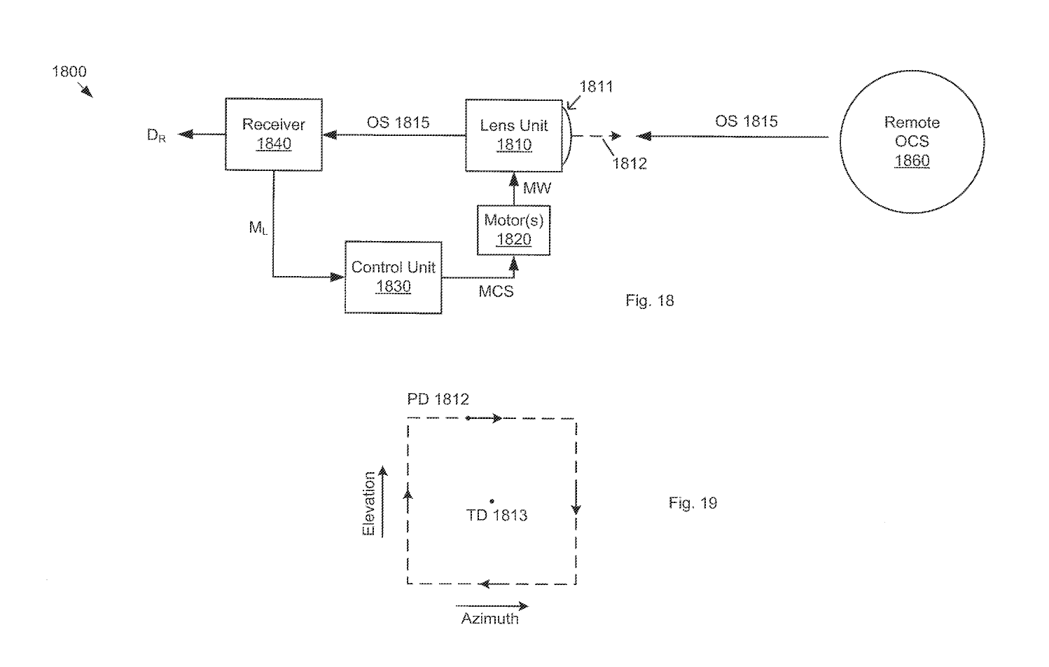

In one set of embodiments, an optical communication system 1800 may be configured as shown in FIG. 18. The optical communication system 1800 may include a lens unit 1810, a set of one or more motors 1820, a control unit 1830 and a receiver 1840. (Furthermore, the optical communication system 1800 may include any subset of the features, embodiments and elements described above in connection with system 100 and described below in connection with system 2400 and system 3100.)

The lens unit 1810 includes a lens 1811. The lens 1811 is configured to receive an optical signal 1815 from space. The optical signal 1815 is transmitted from a remote optical communication system 1860. (In some embodiments, the remote optical communication system 1860 may be realized by remote optical communication system 160 as variously described above. Furthermore, lens 1811 may be realized by lens L₂ as variously described above.)

The one or more motors 1820 may be configured to adjust a pointing direction 1812 of the lens 1811 or of the lens unit 1810. The pointing direction 1812 may represent a direction of optimal sensitivity to received optical signal power. In some embodiments, the pointing direction may correspond to the optical axis of the lens 1811.

The control unit 1830 may be configured to control the one or more motors 1820 so as to move the pointing direction 1812 through a path centered on (or, specified relative to) a current target direction 1813, e.g., as suggested by FIG. 19. In some embodiments, the control unit 1830 may be realized by the control unit 140 as variously described above.

The receiver 1840 may be configured to capture measurements M_{L} of strength of the optical signal 1815 while the pointing direction 1812 is moved through the path. The control unit 1830 is configured to control the one or more motors 1820 so as to adjust the target direction 1813 based on a data set including the captured measurements M_{L}.

In some embodiments, the receiver 1840 is configured to recover a data stream D_{R} from the optical signal 1815.

In some embodiments, the optical signal 1815 is a multimode optical signal, and the receiver 1840 is the only optical receiver of the optical communication system 1800.

In some embodiments, the remote optical communication system 1860 performs forward error correction (FEC) encoding on the data stream D_{R} prior to modulating the optical signal 1815 with the data stream D_{R}. Thus, the receiver may also be configured to perform forward error correction (FEC) decoding on the recovered data stream D_{R} to obtain a decoded data stream.

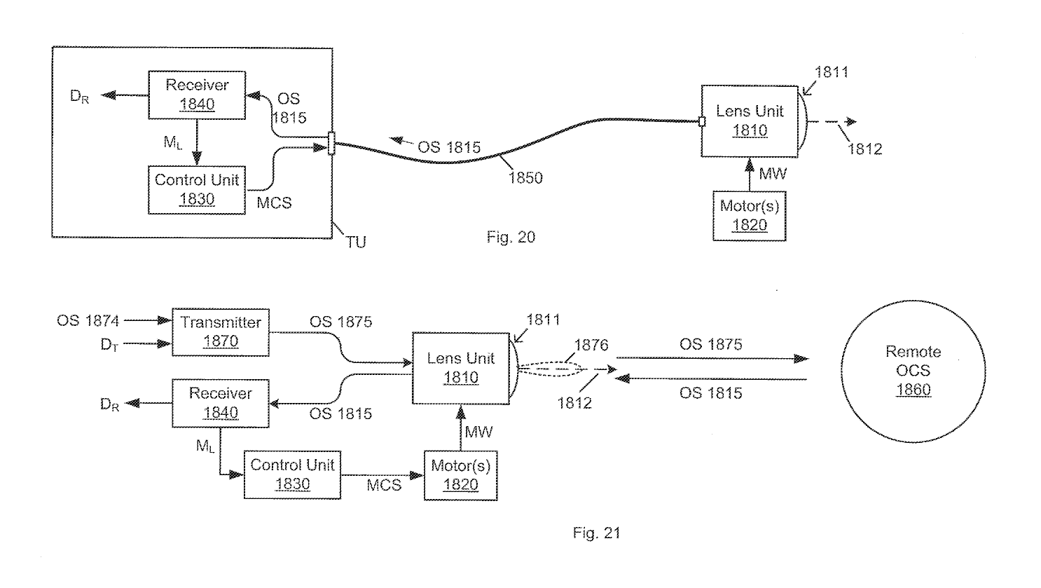

In some embodiments, the receiver 1840 and at least a portion of the control unit 1830 are incorporated in a terminal unit TU, e.g., as shown in FIG. 20. The terminal unit TU is configured for coupling to the lens unit 1810 via one or more cables. The lens unit 1810 is configured to supply the optical signal 1815 to the terminal unit through the one or more cables. FIG. 20 shows the case where a single cable (cable 1850) is used to send the optical signal 1815 from the lens unit to the terminal unit, and to send motor control signal MCS from the terminal unit to the lens unit 1810 (destined for the one or more motors 1820).

The lens unit 1820 may be configured for outdoor operation, e.g., as variously described above.

In some embodiments, the terminal unit TU may also be configured to supply power to the lens unit 1810 through the one or more cables. The supplied power may be used by the lens unit 1810 and/or the one or more motors 1820.

In some embodiments, the lens unit 1810 includes (or in contained within) a rain-proof enclosure.

In some embodiments, the optical communication system 1800 also includes a network interface. As described above, the receiver 1840 is configured to recover the data stream D_{R} from the optical signal 1815. The network interface is configured to extract data packets from the data stream D_{R} and to transmit the data packets onto an external network, e.g., as variously described above.

In some embodiment, the network interface may be configured to support a plurality of network clients simultaneously, e.g., as described below in connection with FIG. 32. Thus, the data packets transmitted onto the external network may include data packets for each of the network clients.

In some embodiments, the network interface may include one or more ports for interfacing with the external network, where one or more of the ports are configured to convey power (from the optical communication system 1800) as well as data. The conveyed power may be used to power external devices, e.g., devices such as one or more radios of any of various kinds and/or one or more of the network clients. The external network may be an Ethernet network, and the ports may be configured to conform with the Power Over Ethernet (PoE) Standard. In one application scenario, a wireless hot spot may couple to the optical communication system 100 through one of the ports, e.g., as described above in connection with optical communication system 100.

In some embodiments, the receiver 1840, the lens unit 1810 and the control unit 1830 are incorporated into a single integrated package. In some embodiment, the one or more motors 1820 may also be included in the integrated package.

In some embodiments, the optical communication system 1800 may also include an optical fiber configured to convey the optical signal 1815 from the lens 1811 to the receiver. For example, the optical fiber may be incorporated into the cable 1850 of FIG. 20.

In some embodiments, the lens 1811 has a Gaussian sensitivity pattern to received optical power. However, the present inventions are not limited to any particular type of sensitivity pattern.

In some embodiments, the one or more motors 1820 include at least an azimuth-adjusting motor and an elevation-adjusting motor.

In some embodiments, the path is a rectangular path (e.g., including segments of constant elevation angle and segments of constant azimuth angle).

In some embodiments, the control unit 1830 includes one or more programmable hardware elements such as FPGAs.

In some embodiments, the control unit 1830 includes one or more processors, each configured to execute program instructions.

The control unit 1830 may be configured to compute an azimuth error and/or an elevation error based on the captured measurements M_{L}. The control unit may control the one or more motors based on the computed azimuth error in order to adjust an azimuth angle of the target direction 1813. Furthermore, the control unit may control the one or more motors based on the computed elevation error in order to adjust an elevation angle of the target direction 1813. The azimuth angle and the elevation angle may both be adjusted simultaneously, or one after the other.

In some embodiments, the control unit 1830 is configured to make a plurality of adjustments to the target direction TD during the movement of the pointing direction PD through the path, where each of the adjustments is based on a corresponding subset of the strength measurements. For example, upon completion of each quadrant (or segment) of the path, the control unit 1830 may compute updated azimuth and elevation error information based on the strength measurements for the just completed quadrant and the other three quadrants. If one or more of the other three quadrants have not yet been visited in the present movement of pointing direction, strength measurements from a previous path movement (previous traversal of the path) may be used for those quadrants.

In some embodiments, the optical communication system 1800 may also include a transmitter 1870, e.g., as shown in FIG. 21. The transmitter 1870 may be configured to modulate a data stream D_{T} onto an optical signal 1874 to obtain a modulated second optical signal 1875. The transmitter 1870 supplies the modulated optical signal 1875 to the lens 1811. The lens 1811 is configured to transmit the optical signal 1875 into space as a beam 1876, e.g., as variously described above.

In some embodiments, the control unit 1830 may be configured to extract feedback information FBI from the data stream D_{R}. The feedback information FBI is generated by the remote optical communication system 1860. The feedback information includes (or is based) on measurements M_{R} of strength of the beam 1876 as received by the remote optical communication system 1860 during the movement of the pointing direction 1812 of the lens 1811 through the path. The data set used to determine the adjustment to the target direction may also include the feedback information FBI.

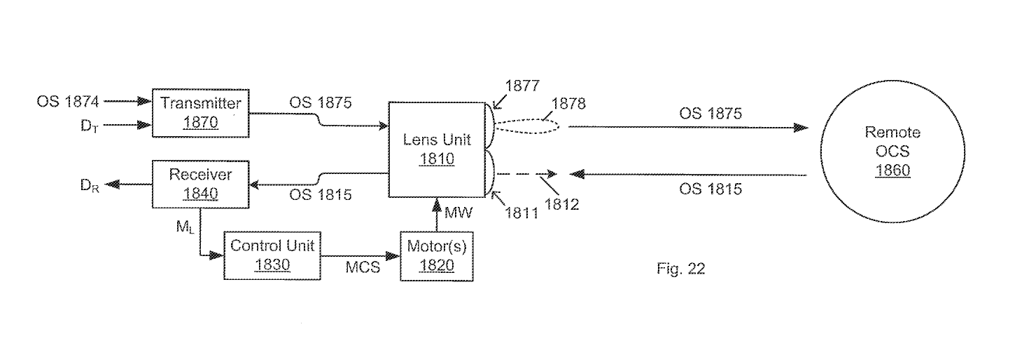

In some embodiments, the lens unit 1810 may also include a lens 1877 in addition to the lens 1811, e.g., as shown in FIG. 22. The transmitter 1870 supplies the modulated optical signal 1875 to the lens 1877. The lens 1877 is configured to transmit the modulated optical signal 1875 into space as a beam 1878. In these embodiments, the action of moving the pointing direction 1812 through the path may also move a pointing direction of the lens 1877 through the same path. For example, the lens 1877 and the lens 1811 may be rigidly mounted in the lens unit 1810 so that their pointing directions agree. Thus, moving (e.g., rotating) the lens unit automatically moves both pointing directions simultaneously.

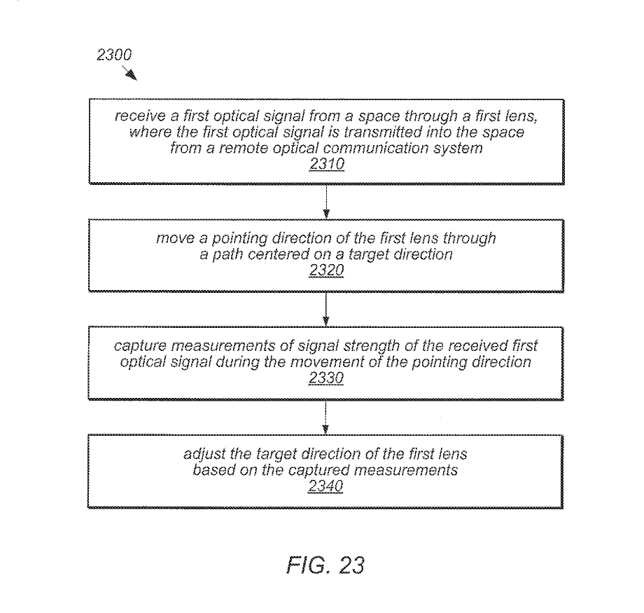

In one set of embodiments, a method 2300 for operating an optical communication system may involve the operations shown in FIG. 23. (Furthermore, the method 2300 may include any subset of the features, embodiments and elements described above.) The method 2300 may be employed to acquire communication with a remote optical communication system.

At 2310, a first optical signal is received from a space through a first lens, e.g., as variously described above. See, e.g., the optical signal 1815 and the lens 1811 of FIG. 18. The first optical signal is transmitted into the space from the remote optical communication system (e.g., the remote optical communication system 1860 as described above).

At 2320, a pointing direction of the first lens is moved through a path centered on a target direction, e.g., as variously described above. See especially the pointing direction 1812 and target direction 1813 of FIGS. 18 and 19.

At 2330, measurements M_{L} of signal strength of the received first optical signal are captured during the movement of the pointing direction.

At 2340, the target direction of the first lens is adjusted based on the captured measurements, e.g., as variously described above. The pointing direction may be moved to the target direction before adjusting the target direction.

In some embodiments, the method 2300 may include repeating the set of operations including operations 2320, 2330 and 2340, e.g., using successively smaller sizes (e.g., diameters or side lengths) for the path in successive repetitions.

In some embodiments, the action 2340 of adjusting the target direction includes making a plurality of adjustments to the target direction during the movement of the pointing direction through the path, where each of the adjustments is based on corresponding subject of the captured measurements, e.g., as described above in connection with system 1800.

In some embodiments, method 2300 may be employed before two-way optical communication (or even before one-way optical communication) has been established between the optical communication system and the remote optical communication system.

In some embodiments, the method 2300 may also include: recovering a first data stream from the received first optical signal; and performing forward error correction (FEC) decoding on the first data stream to obtain a decoded data stream.

In some embodiments, the method 2300 may also include: recovering a first data stream from the received first optical signal; modulating a second optical signal with a second data stream to obtain a modulated second optical signal; and transmitting the modulated second optical signal into space through the first lens.

In some embodiments, the method 2300 may also include performing the following set of operations after the action 2340 of adjusting the target direction. The set of operations may include: moving the pointing direction of the first lens through a second path centered on the target direction during said transmitting of the modulated second optical signal; extracting feedback information from the first data stream, where the feedback information includes or is based on measurements of strength of the modulated second optical signal as received by the remote optical communication system during said movement of the pointing direction through the second path; capturing additional measurements M_{L} of signal strength of the received first optical signal during the movement of the pointing direction through the second path; and performing a tracking adjustment of the target direction of the first lens based on the feedback information and/or the captured additional measurements.

In some embodiments, the method 2300 may also include: recovering a first data stream from the received first optical signal; modulating a second optical signal with a second data stream to obtain a modulated second optical signal; and transmitting the modulated second optical signal into space through a second lens. (The optical axes of the first and second lenses may be configured to be parallel so that their pointing directions agree.)

In some embodiments, method 2300 may also include performing the following set of operations after the action 2340 of adjusting the target direction. The set of operations may include: moving the pointing direction of the second lens through a second path centered on the target direction during said transmitting of the modulated second optical signal; extracting feedback information from the first data stream, where the feedback information includes or is based on measurements of strength of the modulated second optical signal as received by the remote optical communication system during said movement of the pointing direction of the second lens through the second path; capturing additional measurements of signal strength of the received first optical signal during the movement of the pointing direction of the second lens through the second path; performing a tracking adjustment of the target direction of the first lens based on the feedback information and/or the captured additional measurements.

In different embodiments, the optical communication system may or may not transmit an optical signal (e.g., a modulated optical signal) to the remote optical communication system while method 2300 is being performed.

Node B Sends Received Signal Strength Information to Node A

In one set of embodiments, an optical communication system 2400 may be configured as shown in FIG. 24. The optical communication system 2400 may include a transmitter 2410, a lens unit 2420, a receiver 2430 and a control unit 2440. (Furthermore, optical communication system 2400 may include any subset of the features, embodiments and elements described above in connection with system 100 and system 1800 and described below in connection with system 3100.)

The transmitter 2410 may be configured to modulate a data stream D_{T} onto an optical signal 2408 to obtain a modulated optical signal 2412. The modulation may be performed using conventional modulation device(s) and/or conventional modulation methods. The optical signal 2408 may be generated by a laser device. In some embodiments, the optical communication system 2400 includes only a single laser device. In some embodiments, the laser device is a multimode laser, and the optical signal 2408 is a multimode optical signal.

The lens unit 2420 may be configured to transmit the modulated optical signal 2412 into space, e.g., as variously described above. The lens unit 2420 may include on or more lenses. The lens unit is also configured to receive an optical signal 2422 from the space. The optical signal 2422 is transmitted as a beam from a remote optical communication system 2460. (The remote optical communication system 2460 may be realized by optical communication system 160 or optical communication system 1860, as variously described above.)

The receiver 2430 may be configured to recover a data stream D_{R} from the optical signal 2422. The receiver 2430 may be further configured to capture measurements M_{R} of strength of the received optical signal 2422 while the remote optical communication system 2460 moves a pointing direction of the beam through a path centered on a target direction.

In some embodiments, the optical communication system 2400 may include a network interface (e.g., as variously described above in connection with system 100 or system 1800 or below in connection with system 3100). The network interface may be configured to extract data packets from the data stream D_{R} and transmit the data packets onto an external network, and, to receive data packets from the external network and inject the received data packet packets into the data stream D_{T} for transmission over the link.

The control unit 2440 may be configured to embed (i.e., inject or insert) the captured measurements M_{R} (or data derived from the captured measurements M_{R}) into the data stream D_{T} to enable the remote optical communication system 1860 to correct the target direction of the beam.

In some embodiments, the transmitter 2410 may be configured to perform forward error correction (FEC) encoding on the data stream D_{T} prior to modulating the data stream D_{T} onto the optical signal 2408. The receiver 2430 may be configured to perform FEC decoding on the data stream D_{R} recovered from the optical signal 2422.

In some embodiments, the transmitter 2410, the receiver 2430 and at least a portion of the control unit 2440 are incorporated in a terminal unit TU, e.g., as shown in FIG. 25. The terminal unit TU may be configured for coupling to the lens unit 2420 via one or more cables, e.g., as variously described above. The terminal unit TU may be configured to supply the modulated optical signal 2412 to the lens unit through the one or more cables. Furthermore, the lens unit 2420 may be configured to supply the received optical signal 2422 to the terminal unit TU through the one or more cables. FIG. 25 shows the example of a single cable, i.e., cable 2415, being used to carry both optical signals 2412 and 2422. The cable 2415 may also be configured to supply power to the lens unit 2420. The supplied power may be used the lens unit 2420 and/or by one or motors as variously described above.

The lens unit 2420 may be configured for outdoor operation. The terminal unit TU may be configured for indoor operation.

In some embodiments, the transmitter 2410, the receiver 2430, the lens unit 2420, and the control unit 2440 are incorporated into a single integrated package.

In some embodiments, the remote optical communication system 2460 is configured to move the pointing direction of its transmitted beam in a rectangular path.

In some embodiments, the control unit 2440 includes one or more programmable hardware elements such as FPGAs.

In some embodiments, the control unit 2440 includes one or more processors, each configured to execute program instructions.

In some embodiments, the transmitter is configured to modulate the data stream D_{T} onto the optical signal 2408 using a first set of one or more wavelengths, and the optical signal 242 includes a second set of one or more wavelengths. The first set of wavelengths and the second set of wavelengths may be disjoint sets (i.e., have empty intersection).

In some embodiments, the lens unit 2420 includes a single lens, where the single lens is configured to transmit the modulated optical signal 2412 into the space and receive the optical signal 2422 from the space.

In another embodiment, the lens unit 2420 includes two lenses. One of the lenses is configured to transmit the modulated optical signal 2412 into the space, and the other lens is configured to receive the optical signal 2422 from the space, e.g., as variously described above.

In some embodiments, the control unit 2440 is configured to extract messages from the data stream D_{R}. The messages are generated by the remote optical communication system 2420 and indicate respective positions (waypoints) along the path. The control unit 2440 is configured to synchronize the capture of the strength measurements M_{R} with the messages.

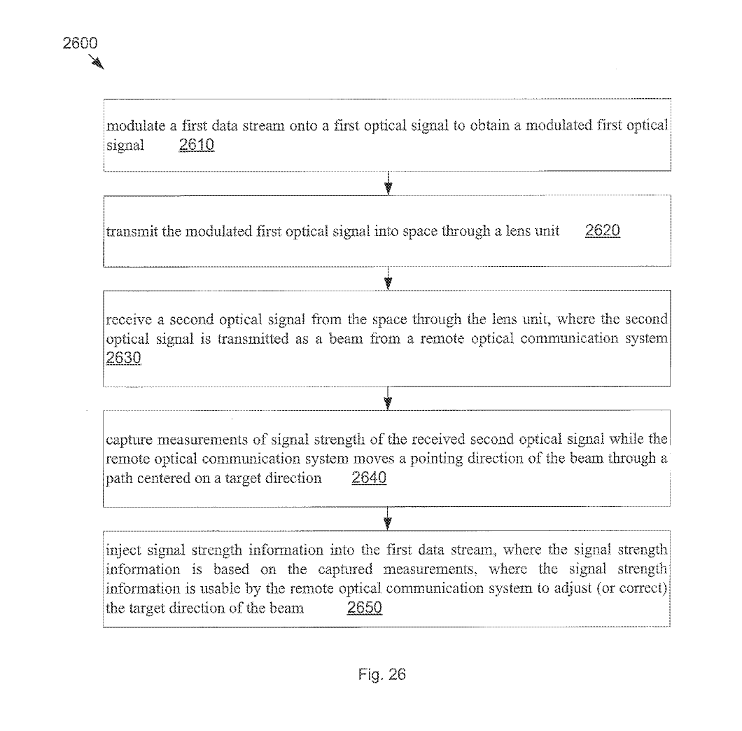

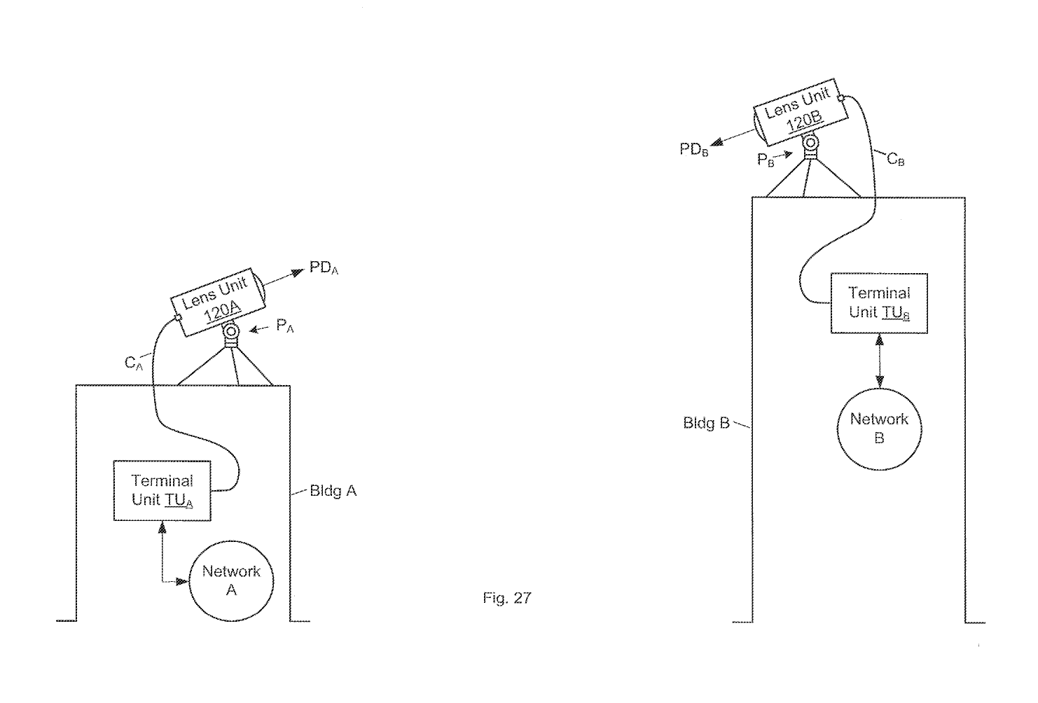

In one set of embodiments, a method 2600 for operating an optical communication system may include the operations shown in FIG. 26. (Furthermore, the method 2600 may include any subset of the features, embodiments, and operations described above.)

At 2610, a first data stream is modulated onto a first optical signal to obtain a modulated first optical signal, e.g., as variously described above.

At 2620, the modulated first optical signal is transmitted into space through a lens unit, e.g., as variously described above.

At 2630, a second optical signal is received from the space through the lens unit, where the second optical signal is transmitted as a beam from a remote optical communication system, e.g., as variously described above.

At 2640, measurements M_{R} of signal strength of the received second optical signal are captured while the remote optical communication system moves a pointing direction of the beam through a path centered on a target direction, e.g., as variously described above.

At 2650, signal strength information is injected into the first data stream, where the signal strength information is based on the captured measurements, where the signal strength information is usable by the remote optical communication system to adjust (or correct) the target direction of the beam

In some embodiments, the method 2600 also includes performing forward error correction (FEC) encoding on the first data stream prior to the action 2610 of modulating.

In some embodiments, the method 2600 also includes: receiving first data packets from an external network; injecting the first data packets into the first data stream; recovering a second data stream from the received second optical signal; and providing second data packets from the second data stream to the external network.

In some embodiments, the method 2600 also includes: recovering a second data stream from the received second optical signal; and extracting synchronization messages from the second data stream. The synchronization messages indicate respective positions along the path. The action 2640 of capturing of signal strength measurements may be synchronized with the synchronization messages.

In some embodiments, the signal strength information includes an azimuth error and/or an elevation error of the target direction (used by the remote optical communication system). The method 2600 may include computing the azimuth error and/or an elevation error based on the captured measurements.

In some embodiments, the path used by the remote optical communication system is a piecewise linear path (e.g., a rectangular path).

FIG. 27 illustrates one typical application scenario, where node A and node B are associated with buildings A and B respectively. A terminal unit TU_{A} of node A may be located inside building A while the lens unit 120A of node A may be mounted on the top (or, an exterior wall) of building A. Terminal unit TU_{A} may couple to the lens unit 120A via a cable C_{A}, e.g., a hybrid electro-optic cable as variously described above. Similarly, terminal unit TU_{B} of node B may be located inside building B while the lens unit 120B of node B may be mounted on the top (or a side wall) of building B. Terminal unit TU_{B} may couple to the lens unit 120B via a cable C_{B}, e.g., a hybrid electro-optic cable as variously described above. The terminal unit TU_{A} may couple to a computer network A in the building A. The terminal unit TU_{B} may couple to a computer network B in the building B. (Network A and/or network B may be coupled to the Internet.) Thus, node A and node B may serve to connect the two computer networks. The lens unit 120A may be mounted on rotatable platform P_{A}, e.g., a platform that admits rotation in both azimuth and elevation. Power and control signals for the motors may be supplied by terminal unit TU_{A} through cable C_{A}. Similarly, the lens unit 120B may be mounted on rotatable platform P_{B}. The tracking algorithm as variously described herein allows each node to track the other so that pointing direction PD_{A} stays at least approximately pointed at lens unit 120B, and pointing direction PD_{B} stays at least approximately pointed at lens unit 120A.

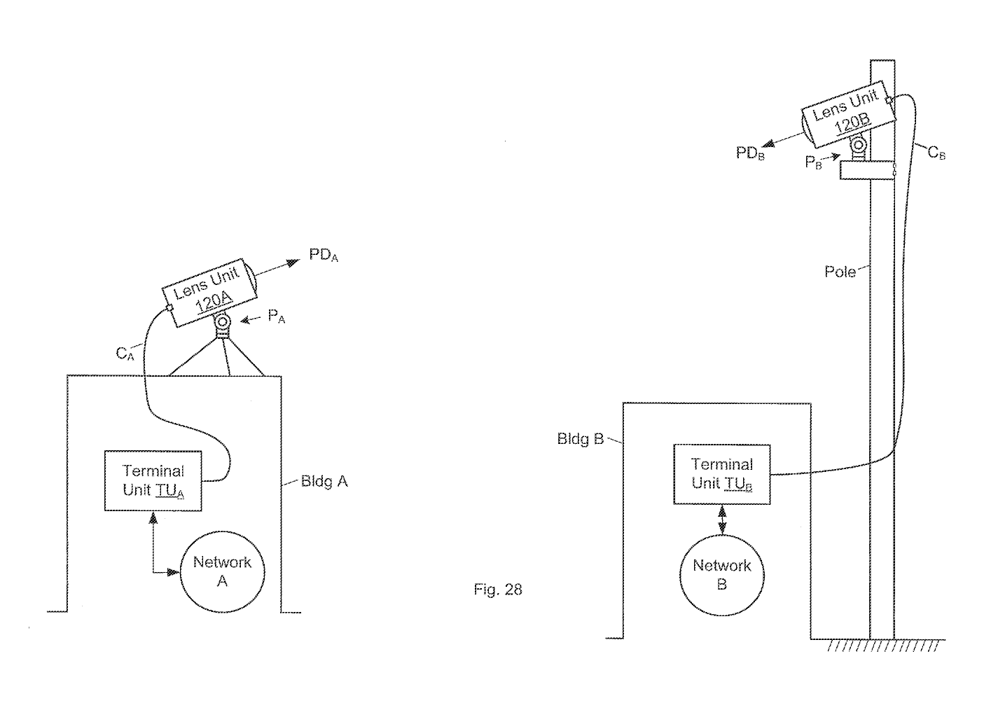

FIG. 28 illustrates another typical application scenario, where the lens unit 120B is mounted on an unstable structure such as a pole or a cell tower or a ship, etc.). In other application scenarios, both lens unit 120A and 120B may be mounted on unstable structures.

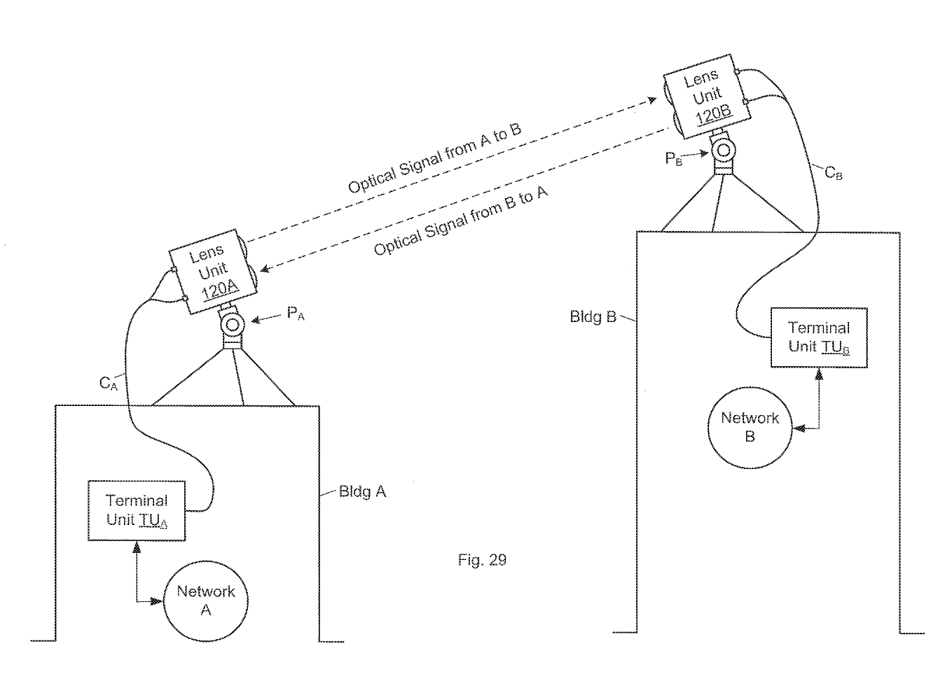

FIG. 29 illustrates an application scenario similar to that of FIG. 27. However, in FIG. 29 the lens units 120A and 120B each include two lenses, one for transmitting and one for receiving, e.g., as variously described above.

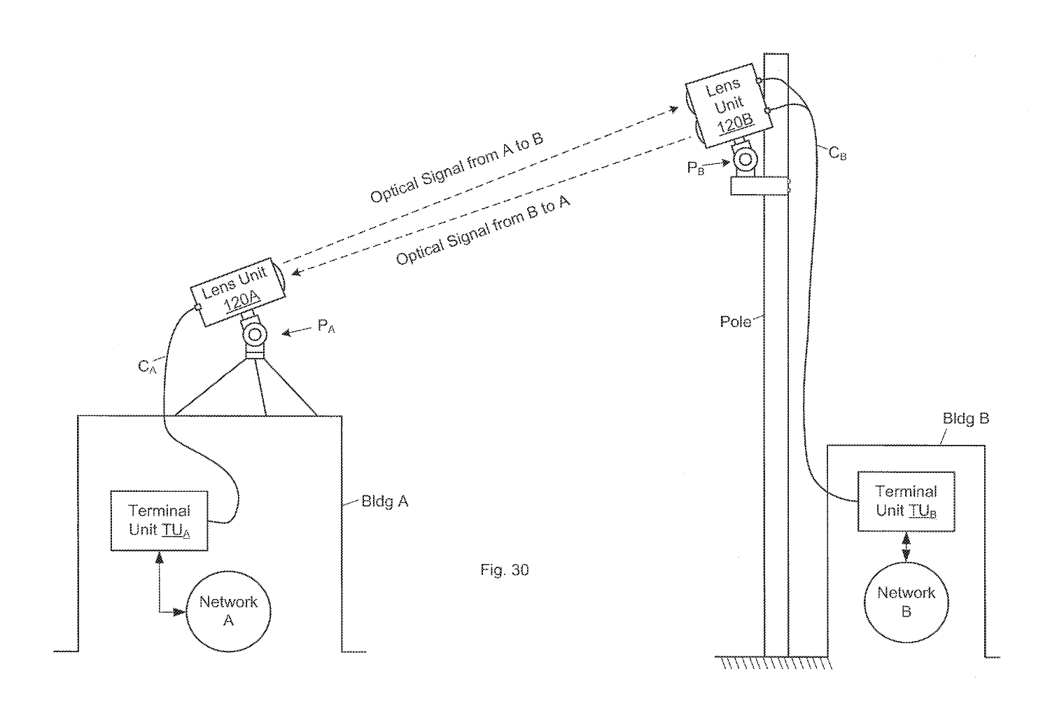

FIG. 30 illustrates an application scenario similar to that of FIG. 28. However, in FIG. 30 the lens unit 120A is of the single-lens variety and lens unit 120B is of the two-lens variety.

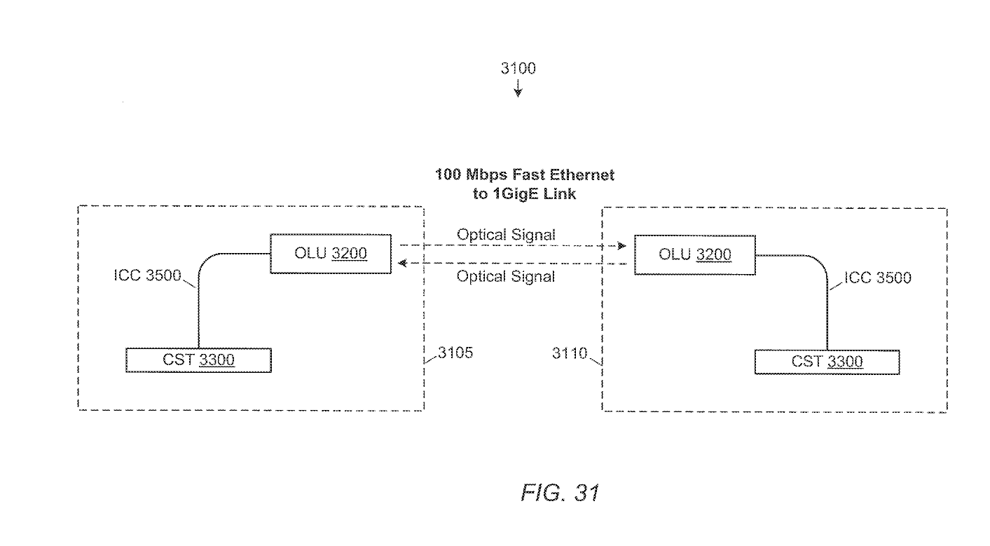

In one set of embodiments, an optical communication system 3100 may be configured as shown in FIG. 31. Optical communication system 3100 includes a near side 3105 and a remote side 3110. (The near side 3105 and the remote side 3110 may include any of the features, embodiments and elements described above. Furthermore, any subset of the features, embodiments and elements described below may be incorporated in any of the various systems and methods described above.) Optical communication system 3100 may be referred to synonymously as the optical wireless broadband (OWB) system. While the optical communication system 3100 is discussed below in terms of components with specific parameter values, it should be understood that each of the those parameter values admits variation, e.g., to meet the design constraints that may be applied to specific embodiments of the system, or to enable different modes of operation. Furthermore, it should be understood that one or more of those components may in some embodiments be omitted, for example, to meet the design constraints that may be unique to given embodiments.

In one embodiment, the communication system 3100 provides up to 1.25 Gbps (e.g., Gigabit Ethernet) connectivity between two points up to 1 mile apart. However, a wide variety of other data rates and distance limits are contemplated.

Each side may include an outdoor lens unit (OLU) 3200 and a communication service terminal (CST) 3300 connected, e.g., via an inter-connect cable (ICC) 3500. In one embodiment, the OLU 3200 and CST 3300 may be combined into a single integrated unit for the purpose of lowering cost and improving tracking speed. In the integrated unit, the ICC 3500 may be replaced with a high speed communication bus, and duplicate electronics may be removed.

In one embodiment, the CST 3300 may provide Gigabit Ethernet (GE) and/or Fast Ethernet (FE) interfaces to the client network. However, a variety of other interface types and combinations of interface types may be used.

The CST 3300 at the near side 3105 may generate an optical signal for wireless transport. The optical signal may be fed through the ICC 3500 to the OLU 3200, where it is propagated through free space. The optical signal may be received at the far-side OLU 3200 and sent to the far-side CST 3300 via the far-side ICC 3500, thus completing the optical signal transmission.

One embodiment of the CST 3300 is shown in FIG. 32. The CST 3300 (also referred to herein as “the terminal” or “terminal unit”) may contain electrical datapath and control circuits for the system as a whole, as well as components for electrical-to-optical and optical-to-electrical signal conversion.

Datapath

The terminal 3300 may provide one or more interface ports of any of various kinds and data rates. For example, in one embodiment, the terminal 300 may provide four Tributary Ethernet Interface ports supporting bi-directional data at rates up to 1.25 Gbps. Three of the four ports (323, 324, 325) support the copper medium only. The fourth port may be configured to support either copper (322) or fiber (321) media, but not both simultaneously. Tributary data streams flow to/from a pair of dual Ethernet PHY devices (305, 306) via 1000Base-T standard signaling (335, 336, 337) for the dedicated copper ports and 1000Base-T or 1000Base-FX standard signaling (338) for the copper/fiber port. All copper ports also support 10Base-T and 100Base-TX standards. The fiber port also supports the 100Base-FX standard.

In some embodiments, the Ethernet ports are configured to source Power Over Ethernet (PoE) per the PoE standard to power radio devices, and thus, provide WiFi, 3G, or 4G coverage for new applications such as small cell and 3G off loading.

The Ethernet PHY devices convert the four media-dependent data streams into four bi-directional media-independent data streams (350, 351, 352, 353). In one embodiment, these four data streams are 1.25 Gbps serial interfaces, utilizing the SGMII standard. The four media-independent data streams are routed to a multi-port Gigabit Ethernet switching device (302). In one embodiment, the Ethernet switch contains five Gigabit-capable Ethernet ports plus one Fast Ethernet dedicated management port. In another embodiment, the switch is bypassed to allow alternative traffic to Ethernet such as SONET/SDH, FDDI, CPRI, Fiber Channel. In this mode, the system may be protocol agnostic.

Bi-directional Ethernet traffic to/from the OWB link is connected to the Ethernet switch via a media-independent interface (354). In one embodiment, this interface is implemented using the 1.25 Gbps SGMII standard. Interface 354 connects the Ethernet switch to the datapath FPGA (600). In the ingress direction (tributary to OWB), an imbedded serializer/deserializer (SerDes) converts the serial data stream into a parallel data bus for processing. The FPGA processes the Ethernet data stream, adding proprietary overhead signaling and forward error correction (FEC) while maintaining the 1.25 Gbps data rate. The internal data is re-timed to the 125 MHz terminal data reference clock (363), generated by crystal oscillator 315. Another imbedded SerDes converts the parallel data back into a serial data stream to be transmitted to a laser driver (304) via a bi-directional 1.25 Gbps interface (364). In the egress direction (OWB to tributary), the FPGA receives a 1.25 Gbps data stream (364) from the limiting amplifier integrated within the laser driver device (304). The link-side imbedded SerDes in the FPGA converts the incoming stream to a parallel bus and re-times the incoming signal to the 125 MHz reference clock (363). FEC overhead is processed and used to correct any transmission errors introduced across the optical link. Other overhead signaling data is recovered and passed on to the control portion of the terminal 3300. The Ethernet traffic payload is then re-serialized by the tributary-side imbedded SerDes and passed to the Ethernet switch via SGMII interface 354.

In one embodiment, the FPGA may be used to buffer the traffic and retransmit packets not received at the remote node. A large buffer enables the system to counter events such as line-of-sight blockages due to obstructions. In one embodiment, flow control may be used to pause traffic in the event of blockages and buffering may be used to retransmit traffic so that no data is lost.

The laser driver device (304) uses the 1.25 Gbps data stream from the FPGA (364) to modulate the current drive signal (365) to a laser (311), thereby converting the electrical data stream into a 1.25 Gbps optical transmit signal (376). In the egress direction, the optical signal from the OWB link (377) is detected and converted to a 1.25 Gbps electrical signal (366) by the Receive Optical Subassembly, or ROSA (312), containing an avalanche photodiode (APD) and a trans-impedance amplifier (TIA). A limiting amplifier integrated in the laser driver device (304) amplifies the recovered electrical signal and transmits the 1.25 Gbps electrical data stream (364) to the FPGA. The optical signals (376, 377) are routed to/from an external optical bulkhead (303).

In some embodiments, the laser 311 is a multimode laser device having multiple spectral lines to aid in atmospheric propagation. Each line has a different path attenuation. Through the concept of frequency diversity, the fluctuation of optical power at the receiver due to the multiple lines is reduced, and thus, tracking accuracy is improved. In some application contexts, the multiple spectral lines may be required for the tracking system to correctly measure the tracking error. In some embodiments, the CST 3300 includes only one laser and only one optical receiver. Thus, in these embodiments, the CST 3300 may be realized at lower cost and reduced size relative to other embodiments that include more than one laser and/or more than one optical receiver.

In the event of a catastrophic failure on the OWB link, the datapath FPGA provides a rapid failover path to a dedicated Ethernet port (334) on the client interface of the terminal. When the FPGA detects the deterioration of the optical link, the bi-directional Ethernet data stream to/from the Ethernet switch (354) is transparently re-routed along a separate 1.25 Gbps path (349) to a gigabit Ethernet PHY device (307). In one embodiment, the interface between the FPGA (600) and the failover PHY (307) is implemented with an SGMII interface. The PHY converts the Ethernet signal into a media-dependent format. The client accessible interface is a dedicated copper port (326), so the media-dependent interface (334) supports 1000Base-T, 100Base-TX, and 10Base-T signaling.

Control

A processor 301 (e.g., a microprocessor chip) may be the primary controlling device for the terminal 3300. The processor 301 may be configured to run any of various operating systems. In one embodiment, processor 301 runs a Linux-based operating system (OS).

In one embodiment, the processor 301 runs at 266 MHz. However, in other embodiments, different clock rates are contemplated.

In one embodiment, the processor 301 utilizes 128 MB of DRAM (310) and 64 MB of flash memory (309). However, in other embodiments, different amounts of DRAM and different amounts of flash memory are contemplated.

In one embodiment, the external volatile system memory interface (361) is implemented with a 133 MHz DDR2 interface. However, other interfaces are contemplated.

In one embodiment, non-volatile memory utilizes the parallel processor bus (359). However, in other embodiments, another bus or set of busses may be utilized.

In one embodiment, the parallel processor bus is 32 bits wide. However, other bit widths are contemplated.

In one embodiment, the parallel processor bus runs at 66 MHz. However, other rates are contemplated.

The parallel processor bus may also connect the processor 301 with the system FPGA 600, allowing system software to control and monitor the functions provided by the programmable hardware element.

The crystal oscillator 317 may provide a reference clock signal 369 for the processor 301. In one embodiment, the reference clock signal is 66.66 MHz.

In one embodiment, real-time clocking applications in the terminal software may use a clock signal 370 (e.g., a 32.768 kHz clock signal) provided by another oscillator crystal 318.

The processor 301 may utilize several low-speed serial interfaces to control peripheral devices in the terminal 3300. A four-wire serial peripheral interface (SPI) bus 345 may be used by software to control and monitor the Ethernet switch 302, as well as the 4-channel analog-to-digital converter 313, which allows analog feedback signals Laser Temperature 373 from the laser 311 and RSSI 374 from the ROSA 312 circuits to be interpreted by software. The ROSA may include an avalanche photo detector (APD) and a RSSI measurement circuit. The RSSI may be the primary feedback mechanism for the active tracking system.

The switch 302 may be used to service multiple clients off the same optical communication link, thus improving overall cost to the customer. In other words, multiple clients may communicate their data at the same time over the optical link between the near side 3105 and far side 3110. The switch 302 may be configured to perform distribution and aggregation functions.

The ROSA 312 may include an optical filter to reduce the noise from external interference sources such as sunlight. The purpose of this filter is to reduce noise and improve the accuracy of the RSSI measurement to improve the performance of the tracking system.

A two-wire Inter-IC Control (I²C) bus 346 may be used to control and monitor several devices in the terminal 3300, e.g., devices including a digital-to-analog converter 314 used to provide a variable analog voltage 375 to the avalanche photodiode in the ROSA 312. The I²C bus may also interface with the laser driver device 304 and the optional SFP fiber interface module used in tributary interface port 321. (An SFP is an acronym for “small form-factor pluggable”.)

Control features may be accessible to the user via several interfaces to the processor. An RS-232 serial control interface 339 may be provided via an external port (328). System management over Ethernet may be provided via an external port (327). This Ethernet management port supports copper media only with an interface (343) that supports either 100Base-TX or 10Base-T Ethernet signaling in one embodiment. This media-dependent signal connects to an Ethernet PHY (308). The processor interfaces to this PHY with a media-independent, bi-directional, parallel signaling bus (358).

In some embodiments, the processor supports a full-speed USB interface (342), which is accessible to the user via a USB device port (330). This interface may require an additional crystal oscillator (316) to provide a 60 MHz reference clock (368).

Other direct user interfaces on the terminal 3300 include a momentary-contact pushbutton (333) to provide an external manual reset signal (341) to the terminal, and indicator LEDs (332) driven by discrete control signals (340) from the processor.

A second media-independent, bi-directional, parallel signaling bus (357) from the processor (301) is connected to the management port of the Ethernet switch (302). This interface can be used to issue control packets into the datapath.

System software has remote connectivity to several other interfaces via its interfaces (345, 359) to the FPGA and Ethernet Switch. Control and monitoring information for the Ethernet PHYs (305, 306) is collected via a two-wire serial management data interface (347) connected between the PHYs and the Ethernet Switch (302). A similar serial management data interface (348) connects the FPGA to the failover PHY (307). A set of discrete digital signals (356) to/from the Ethernet switch are controlled and monitored by the FPGA. The terminal fan assembly (319) is controlled and monitored by a set of signals (371) connected to the FPGA. The terminal 3300 controls the lens subsystem via a full-duplex serial RS-422 control and monitoring interface (367) connected between the FPGA and an external connector (329).

Power

Redundant power signals 344 (e.g., 48V DC power signals) may be used to power the CST 3300. In one embodiment, power entry is made using any one of three power entry points 331. Main power inputs A and B support both positive and negative 48V DC signals. The third option may be for power from an uninterruptable power supply (UPS). The system power block 320 may convert the DC input power (e.g., 48V DC input power) to generate all necessary voltages for terminal components. A power-on reset signal 362 is sent to the processor 301. The power block also generates the +50V DC power supply 372 for the lens subsystem. The lens subsystem power supply is routed to the same connector 329 as the lens control and monitoring interface.

Lens Subsystem 3200

FIG. 33 shows a block diagram of the lens subsystem 3200 of the optical wireless broadband (OWB) system. The lens subsystem include an optical datapath, as well as electrical circuits for motor control and environmental monitoring.

Datapath

In one embodiment, the optical transmit data stream 239 (e.g., 1.25 Gbps optical data stream) enters the lens subsystem via external fiber bulkhead connector 201 and is routed through an optical lens subassembly 214 and across the OWB link. The optical receive data stream 238 (e.g., 1.25 Gbps optical data stream) from the remote end of the OWB link enters the lens subsystem through an optical lens subassembly 215 and is routed to external fiber bulkhead connector 201.

Control

The outdoor lens unit 3200 (also referred to as the “lens subsystem” or the “OLU”) may be controlled by software running on the terminal 3300 via a full-duplex serial communication interface 219 (e.g., an RS-422 interface). This serial interface 219 may enter the lens subsystem through an external connector 216 and connect to the lens subsystem FPGA 700.

External connector 216 may also provide input power 218 (e.g., +50V) sourced from the terminal 3300. The power block 202 may generate all necessary supply voltages for lens subsystem components, as well as a power-on reset signal 240 sent to the FPGA 700.

FPGA configuration code as well as lens subsystem inventory and logging data points may be stored in a flash memory device 203. The flash memory 203 may be accessed by the FPGA via an interface 221 (e.g., a 4-wire serial interface). A crystal oscillator 204 sources a reference clock signal 220 (e.g., a 25 MHz reference clock signal) that drives logic internal to the FPGA. The FPGA 700 may control a block of status LEDs 217 with discrete digital control signals 237.

The FPGA 700 may control two motor controller devices (208, 209) with sets of discrete logic signals (226, 227). The motor controller devices produce analog outputs (228, 229) that respectively move two motors (210, 211), e.g., stepper motors. The stepper motors may be configured to perform the vertical and horizontal alignment of the optical beam carrying the OWB link. The stepper motors may also contain position encoders that provide feedback data (230, 231) to the FPGA. Additional position data may be provided via a set of four switch-closure signals 232 generated from a limit switch assembly 400. These switch-closure signals provide information on proximity to the mechanical travel limits of the stepper motors.

The lens subsystem FPGA 700 may also monitor information collected from a temperature/humidity sensor module 205. The sensor module generates analog signals (235, 236) reflecting the temperature and humidity of the external environment. Two single-channel analog-to-digital converters (206, 207) convert the analog signals to digital format, which can be read by the FPGA via interfaces 233 and 234, e.g., two-wire serial interfaces.

Based on this environmental feedback, the FPGA 700 can send control signals 222 to the power block 202, to enable a supply voltage 223 that powers a heating unit for the optical lenses 212. The heating unit is intended to prevent condensation or ice build-up on the lenses. The heating unit provides its own analog temperature-feedback signal 224. An analog-to-digital converter 213 translates the temperature information to digital format, which can be read by the FPGA via an interface 225 (e.g., a two-wire serial interface).

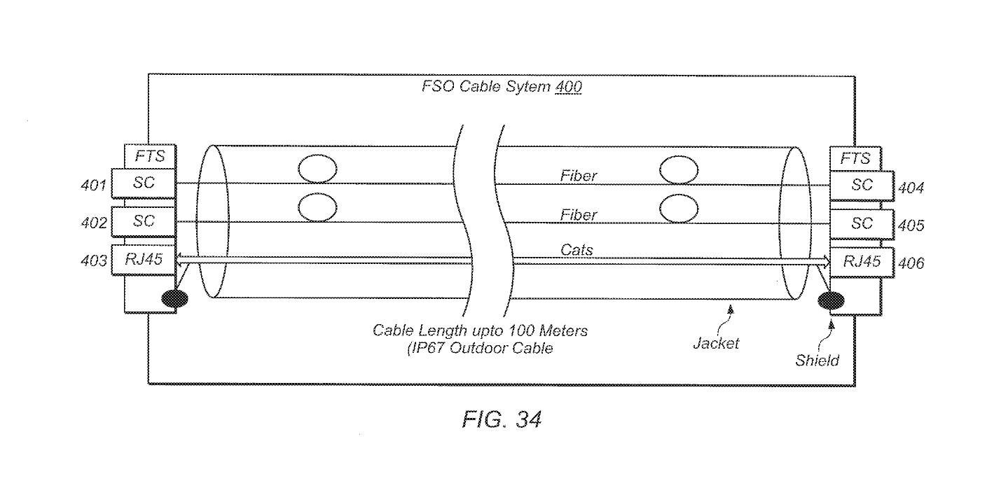

FIG. 34 shows one embodiment of the ICC cable. ICC cable may include a TX fiber cable extending from 401 to 404; an RX fiber cable extending from 402 to 405; and an electrical cable (e.g., CAT5) extending from 403 to 406. In one embodiment, the maximum cable length is 100 meters. However, a wide variety of other limits on cable length are contemplated.) The TX fiber cable takes the TX signal from the CST and inputs to the OLU.

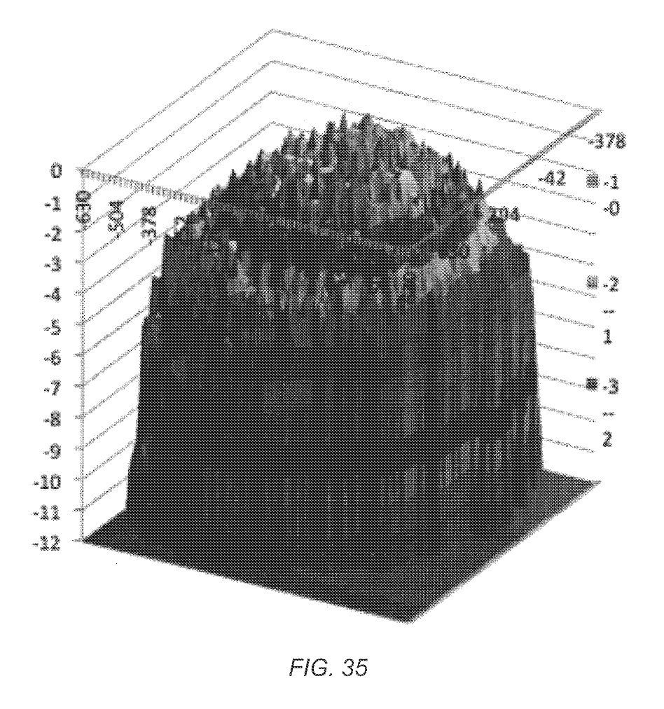

The optical beam transmitted from the OLU 3200 may have any of various shapes. In one embodiment, the shape of the beam is Gaussian, e.g., as illustrated in FIG. 35. In FIG. 35, the vertical scale represents relative optical power, and the horizontal scales represent angular position in units of 20 microradians.

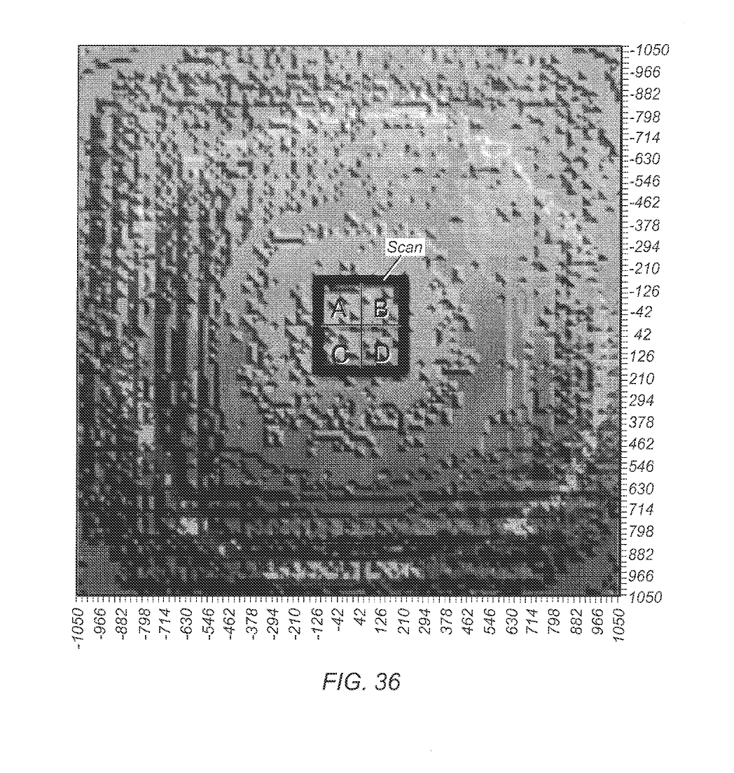

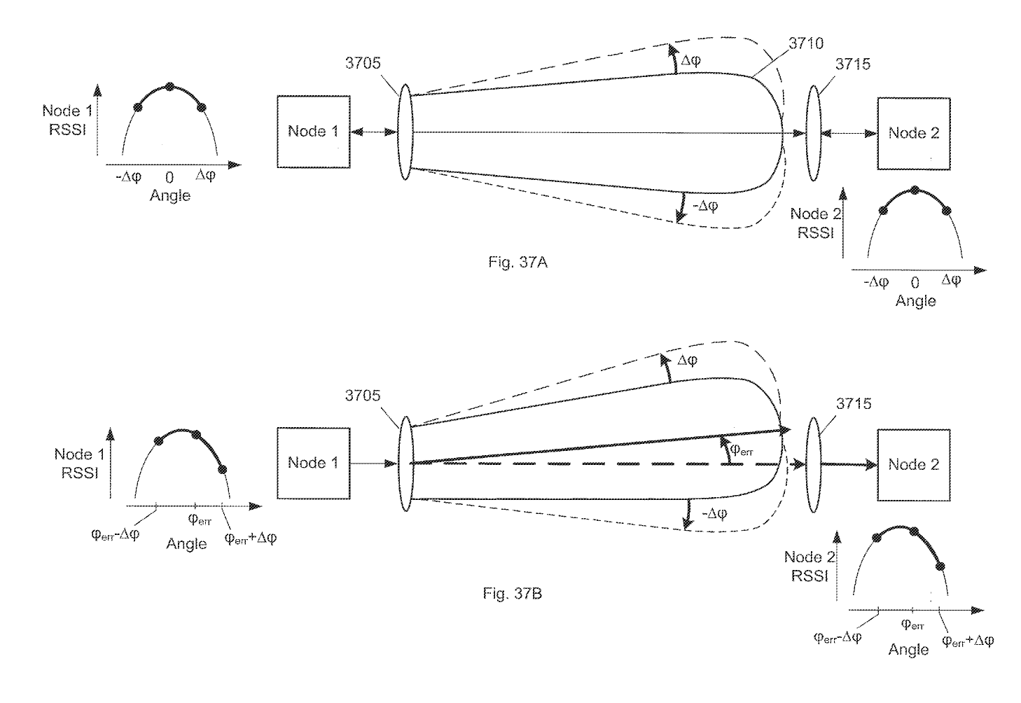

FIG. 36 shows a rectangular scan used in one embodiment to generate the error function. The OLU azimuth and elevation motors may be used to scan (move) the beam along the rectangle (e.g., +/−100 microradians) as represented by the box. As the beam moves along the rectangle, the received power may be measured in sector A, B, C, and D on both sides of the link. From radar principles, the azimuth and elevation errors may be estimated based on the following expressions:

Elevation Error=Δ[(A+B)−(C+D)]

Azimuth Error=Δ[(A+C)−(B+D))]

If the scan is around the center of the beam, the amplitudes of A, B, C, and D will be equal thus minimizing the tracking error. If the beam is off center, the scan will result in a tracking error whose magnitude and direction will point towards the center of the beam.

The OLU may include azimuth and elevation motors to perform the rectangular scan. Each motor may be moved independently to scan across sectors A, B, C and D. The data may be sampled and filtered in each sector to provide an average RSSI number for each sector. (RSSI means “received signal strength indicator”.) A rectangular scan may be used so that only one motor moves at a time, thus minimizing power consumption.

In some embodiments, node 1 (near end) and node 2 (far end) work synchronously to maintain alignment via active tracking. Node 1 may perform a rectangular scan of its transmit beam. Node 1 communicates to Node 2 which sector of the scan is being transmitted, and Node 2 measures RSSI of sectors A, B, C, and D to enable computation of first estimates of azimuth and elevation tracking error. Simultaneously, while scanning, the near end system measures the near-end RSSI for sectors A, B, C and D, i.e., RSSI for the optical signal received from the far end transmitter. (The far end transmitter is preferably not being scanned while the near end is scanning.) The near end uses the near-end RSSI values to compute second estimates of the azimuth and elevation tracking error. The first estimates and the second estimates may be combined (e.g., based on a weighted combination) to form composite estimates. The composite estimates may be used correct the azimuth and elevation of the OLU 3200. In the situation where the OLU includes separate transmit optics and receive optics, tracking based on the first estimates alone tends to optimize the direction the receive optics while tracking based on the second estimates alone tends to optimize the direction of the transmit optics. Tracking based on the composite estimates may provide a balance between the two extremes. That balance may be useful when there are collimation errors between the transmit optics and receive optics.

FIGS. 37A-B illustrate two examples of the scanning process and the corresponding near side and far side RSSI responses. The scanning is illustrated only in one angular coordinate for the sake of diagrammatic simplicity. The transmit beam 3710 of node 1 is scanned up and down by angle Δφ around a current target direction. In FIG. 37A, the transmit beam 3710 of node 1 is assumed to be pointed directly at the optical antenna 3715 of node 2, and the transmit beam (not shown) of node 2 is assumed to be pointed directly at the optical antenna 3705 of node 1. In this case the RSSI responses captured by node 1 and node 2 during the scan are both symmetric. In FIG. 37A, the transmit beam 3710 of node 1 is assumed to be misaligned by an amount φₑᵣᵣ. Thus, the RSSI responses captured by node 1 and node 2 during the scan are both non-symmetric. Furthermore, the difference between the RSSI values at the extremes of the scan, RSSI(φₑᵣᵣ+Δφ)−RSSI((φₑᵣᵣ+Δφ), is indicative of the magnitude and sign of φₑᵣᵣ.

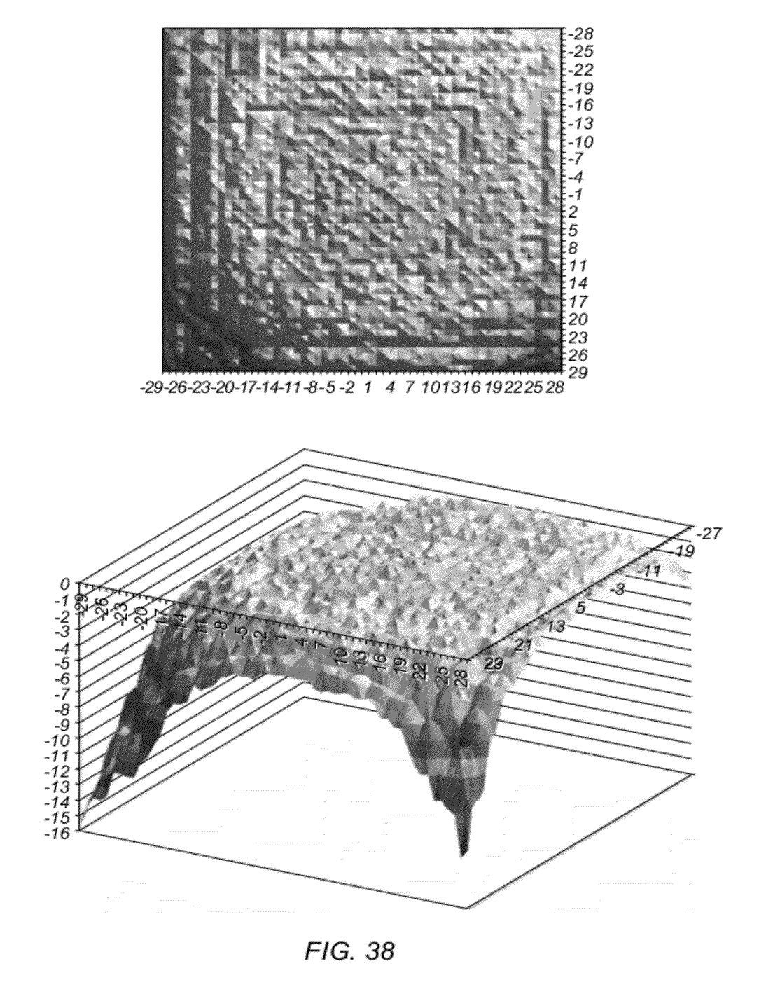

FIG. 38 shows the Node 1 RSSI scan with Node 1 scanning Node 1 is performing a rectangular scan and the RSSI of the far end transmitter is being sampled simultaneously at Node 1. The Node 1 scan stays relatively flat. This shows that as long as the Node 2 peak of the beam is pointing towards Node 1, the RSSI stays fairly constant and independent of the pointing angle of the transmitter. (Near side scan shows a non-Gaussian beam shape and minimal tracking error as a function of OLU transmitter pointing angle.)

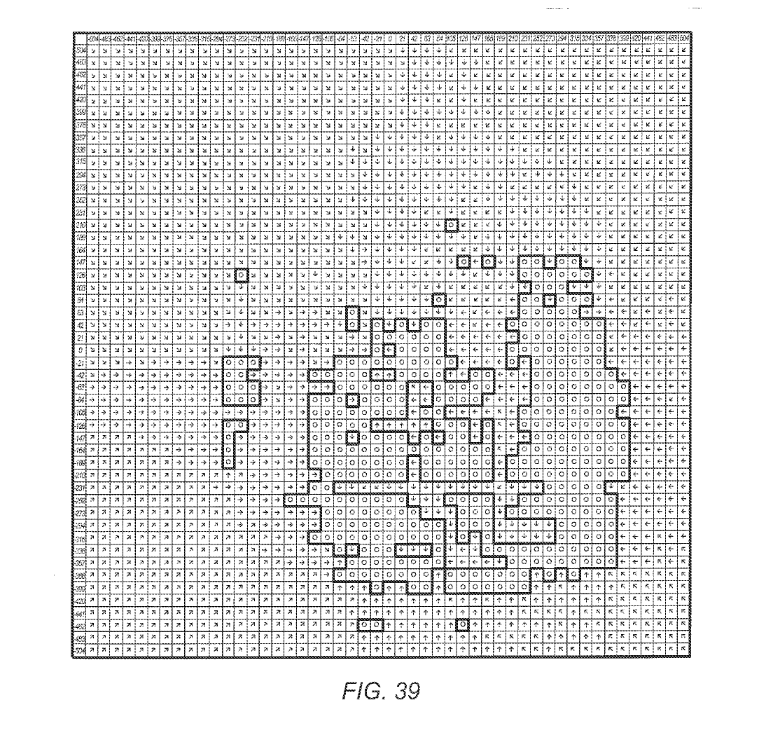

FIG. 39 shows that the near-end scan alone is insufficient to converge to the peak of the beam for precise tracking as there are a large number of valid solutions for convergence and not necessarily at the center of the beam. In other words, near-side scan shows minimal tracking error across a wide range of azimuth and elevation angles thus cannot converge on a solution alone.

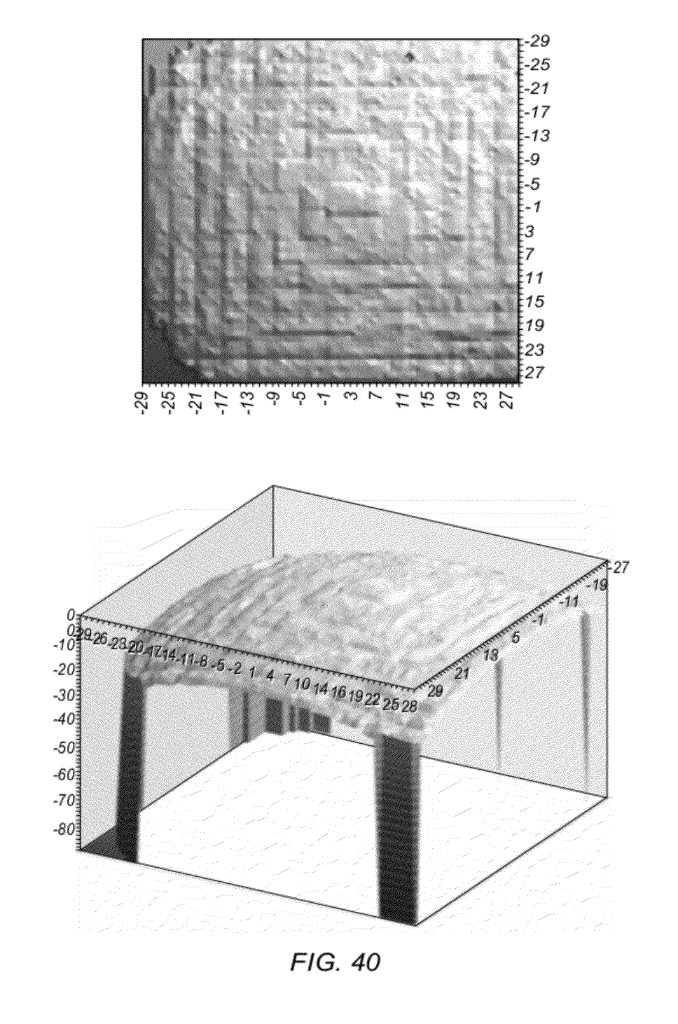

FIG. 40 shows the Node 2 RSSI profile scan with Node 1 scanning also called far side scan. As shown in FIG. 40, the scan is fairly Gaussian and there is a distinct error function as a function of angle. The highest power converges to the center of the beam. (In other words, far-side RSSI shows a Gaussian shape with a distinct center.)

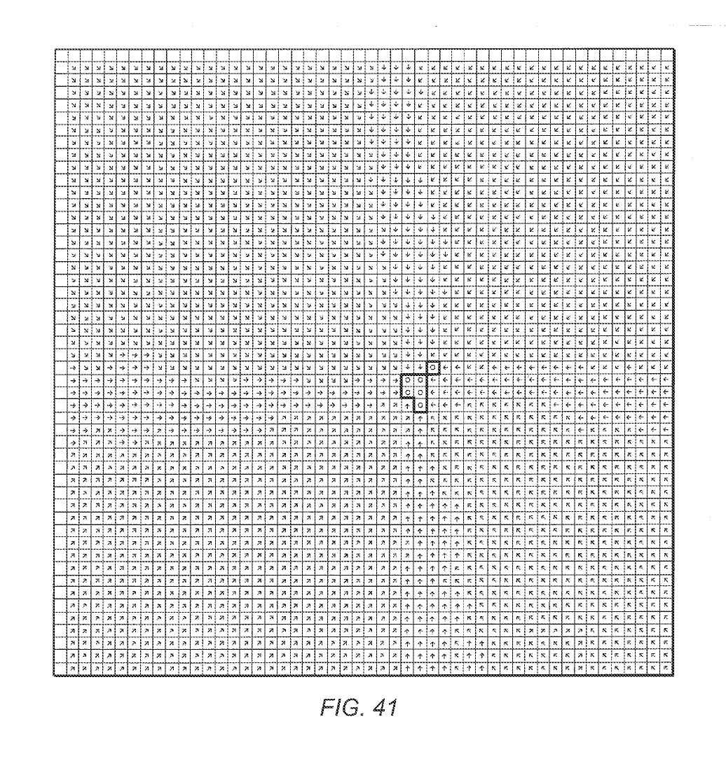

FIG. 41 shows that the far side tracking error (far side error function) converges to the center of the beam, thus allowing the near side OLU to move its beam such that the beam center points to the far side OLU.

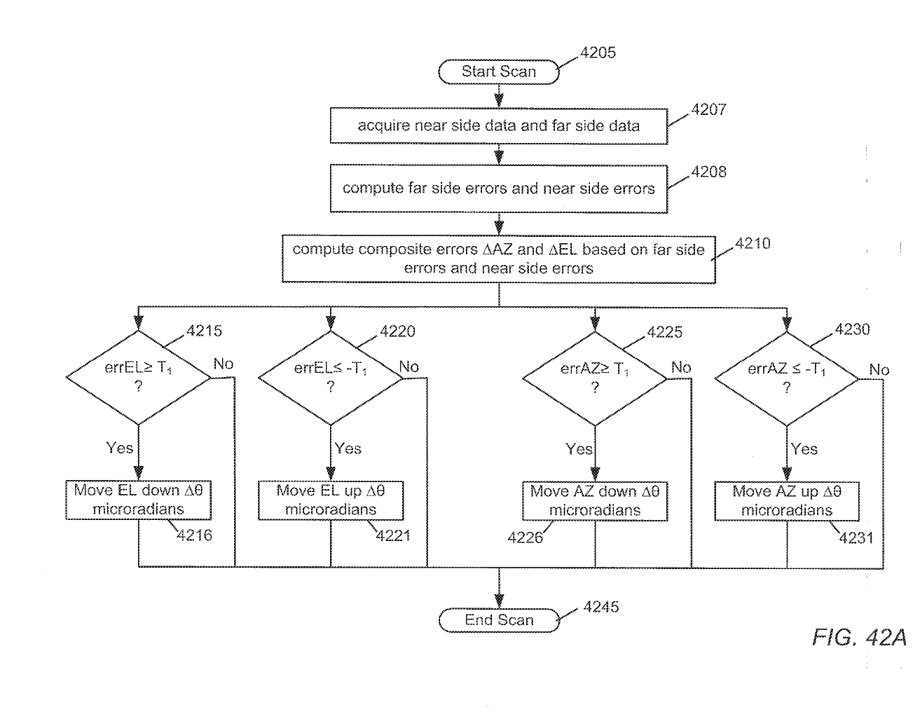

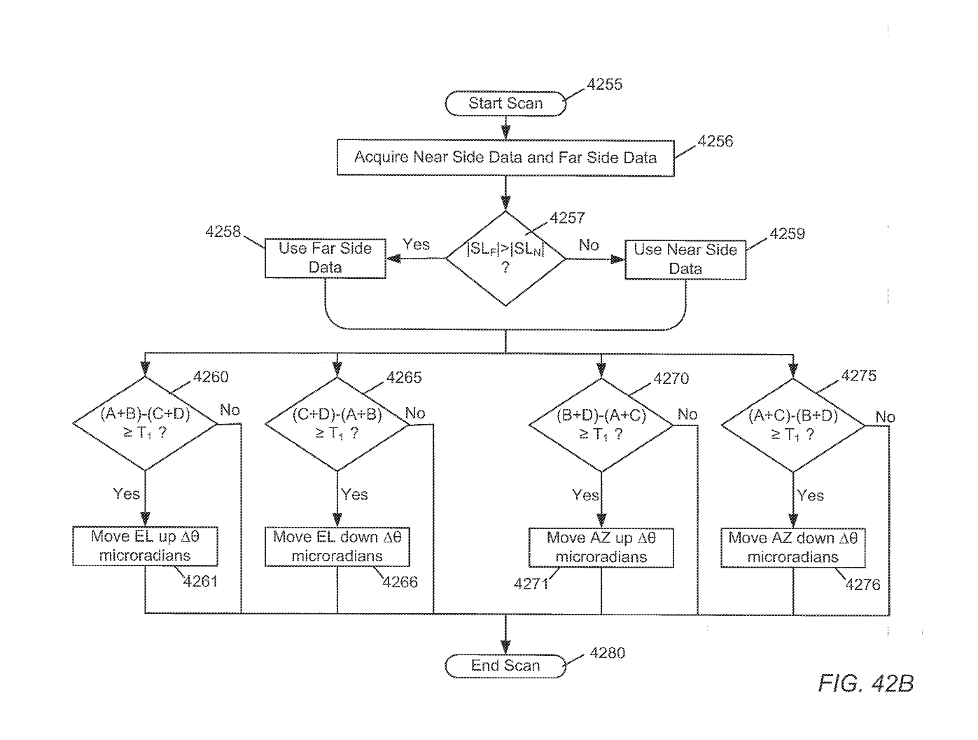

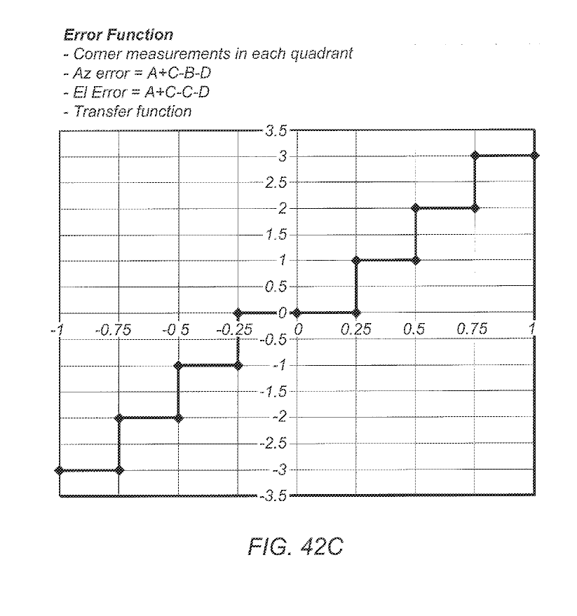

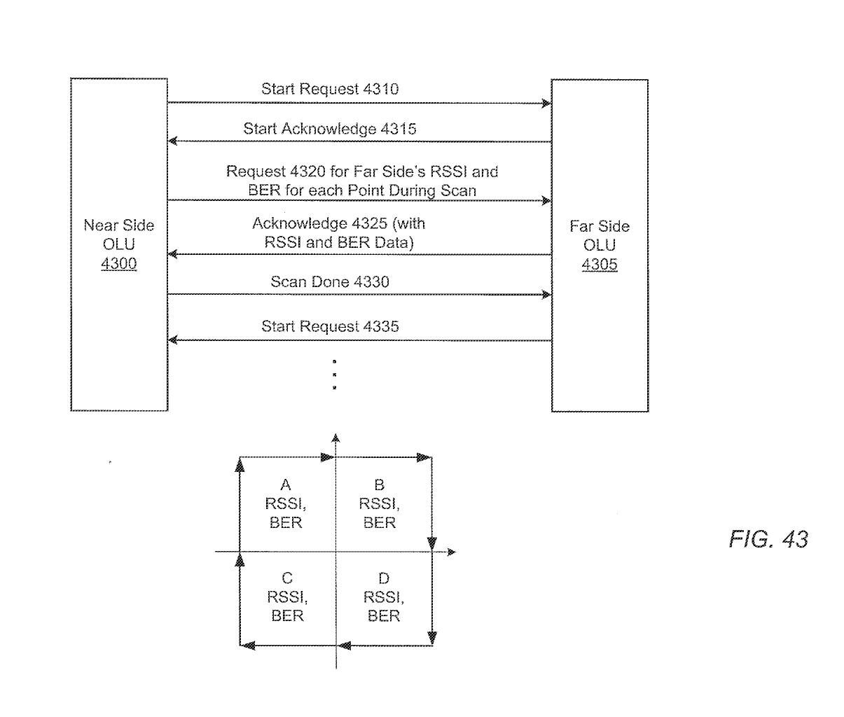

FIG. 42A shows one embodiment of a tracking method. At 4205 the near side starts scanning its pointing direction PD around the target direction, e.g., in a rectangular pattern. At 4207, the near side acquires near side data from the near side receiver, and acquires far side data from the far side as variously described above. The near side data may include an RSSI (received signal strength indicator) for each of the four quadrants A, B, C and D. See FIG. 43. Similarly, the far side data may include an RSSI for each of the four quadrants.

At 4208, the near side may compute far side azimuth error errAZ_{F} and far side elevation error errEL_{F} based on the far side data, and compute near side azimuth error errAZ_{N} and near side elevation error errEL_{N} based on the near side data. (The far side errors may alternatively be computed by the far side and sent to the near side via the optical link.)

At 4210, the near side may compute composite azimuth error errAZ and composite elevation error errEL based on the far side errors and the near side errors, e.g., according to the expressions:

errAZ=W_{AZ,N}*errAZ_{N}+W_{AZ,F}*errAZ_{F}

errEL=W_{EL,N}* errL_{N}+W_{EL,F}*errEL_{F},

where the values W_{AZ,N}, W_{AZ,F}, W_{EL,N} and W_{EL,F} are positive weighting factors.

At 4215, the condition errEL≧T₁ is evaluated. At 4220, the condition errEL≦−T₁ is evaluated. At 4225, the condition errAZ≧T₁ is evaluated. At 4230, the condition errAZ≦−T₁ is evaluated. If the first condition evaluates as TRUE, the near side moves (4216) the elevation angle of its target direction down by Δθ. If the second condition evaluates as TRUE, the near side moves (4221) the elevation angle of its target direction up by Δθ. If the third condition evaluates as TRUE, the near side moves (4226) the azimuth angle of its target direction down by Δθ. If the fourth condition evaluates as TRUE, the near side moves (4231) the azimuth angle of its target direction up by Δθ. If any of the four conditions evaluates as FALSE, the corresponding movement is not performed. The four conditions may be evaluated in any order. In some embodiments, the four conditions may be evaluated in parallel. After all the conditions have been evaluated and the movements have been executed for any conditions that evaluate as TRUE, the scan concludes (4245), whereupon the remote side may start a scan.

The value T₁ is a positive threshold value that may vary from one embodiment to the next, or, from one application context to the next. For example, in one embodiment, T₁ equals 1 dB. Similarly, the value Δθ is a positive value that may vary from one embodiment to the next, or, from one application context to the next. For example, in one embodiment, Δθ equals 21 microradians. In another embodiment, Δθ equals 40 microradians.

FIG. 42B shows an alternative embodiment of a tracking method. At 4255 the near side starts scanning its pointing direction PD around the target direction, e.g., in a rectangular pattern. At 4256, the near side acquires near side data from the near side receiver and far side data from the far side as variously described above. The near side data may include an RSSI (received signal strength indicator) for each of the four quadrants A, B, C and D. See FIG. 43. Similarly, the far side data may include an RSSI for each of the four quadrants.

At 4257, a far side slope SL_{F} is compared to a near side slope SL_{N}. If the far side slope is greater than the near side slope in absolute value, the far side data is used to determine azimuth and elevation adjustments, as indicated at 4258. Otherwise, the near side data is used to determine azimuth and elevation adjustments, as indicated at 4259. The near side slope may be interpreted as an estimate of the gradient of the near side RSSI as a function of azimuth and elevation. Similarly, the far side slope may be interpreted as an estimate of the gradient of the far side RSSI as a function of azimuth and elevation. There are a wide varieties of ways to compute such estimates. For example, in one embodiment, the slopes may be computed based on the following expressions:

SL_{N}=max {(A_{N}−B_{N})+(C_{N}−D_{N}),(A_{N}−C_{N})+(B_{N}−D_{N})}

SL_{F}=max {(A_{F}−B_{F})+(C_{F}−D_{F}),(A_{F}−C_{F})+(B_{F}−D_{F})},

where A_{N}, B_{N}, C_{N} and D_{N} represent near side data, and A_{F}, B_{F}, C_{F} and D_{F} represent far side data.

At 4260, the condition (A+B)−(C+D)>T₁ is evaluated. At 4265, the condition (C+D)−(A+B)>T₁ is evaluated. At 4270, the condition (B+D)−(A+C)>T₁ is evaluated. At 4275, the condition (A+C)−(B+D)>T₁ is evaluated. If the first condition evaluates as TRUE, the near side moves (4261) the elevation angle of its target direction up by Δθ. If the second condition evaluates as TRUE, the near side moves (4266) the elevation angle of its target direction down by Δθ. If the third condition evaluates as TRUE, the near side moves (4271) the azimuth angle of its target direction up by Δθ. If the fourth condition evaluates as TRUE, the near side moves (4276) the azimuth angle of its target direction down by Δθ. If any of the four conditions evaluates as FALSE, the corresponding movement is not performed. The four conditions may be evaluated in any order. In some embodiments, the four conditions may be evaluated in parallel. After all the conditions have been evaluated and the movements have been executed for any conditions that evaluate as TRUE, the scan concludes (4280), whereupon the remote side may start a scan.

In some embodiments, the near side data also includes a BER value for each of the four quadrants, and the far side data also includes a BER value for each of the four quadrants. The BER may be used to sense the edge to the beam. The middle of the beam is error free. As the edge if the beam is approached, the forward error correction algorithm reports corrected errors. Beyond the edge of the beam, the FEC starts to report uncorrected errors. The BER statistics, corrected and uncorrected, can be used to sense the edge of the beam and used along with RSSI to steer the system in the right direction.

In some embodiments, both near side and far side error functions may be used by the near side to determine the tracking error. The total elevation error may be computed as a weighted sum of the near side and far side elevation error. (Far side elevation error also referred to herein as primary elevation deviation. Near side elevation error is also referred to herein as secondary elevation deviation.) The total azimuth error may be computed in a similar manner.

ElevationError=w1e*NearSideElevationError+w2e*FarSideElevationError

AzimuthError=w1a*NearSideAzimuthError+w2a*FarSideAzimuthError,

w1e, w2e, w1a and w2a are positive weights values.

In one embodiment, if the absolute value of the elevation error exceeds an elevation error threshold, the elevation motor may be moved +/− 1 count, with direction dependent on the sign of the elevation error. Similarly, if the absolute value of the azimuth error exceeds an azimuth error threshold, the azimuth motor may be moved +/− 1 count, with direction dependent on the sign of the azimuth error.

In one embodiment, the tracking system moves the elevation component of the target direction by the constant amount Δθ if the elevation error is positive and above an elevation error threshold. Symmetrically, the tracking system moves the elevation component of the target direction by −Δθ if the elevation error is negative but has absolute value above the elevation threshold. The azimuth component of the target direction may be moved based on the azimuth error using similar logic.

In one embodiment, the angular movement of the elevation component or azimuth component of the target direction may be implemented with more than one threshold value, e.g., as shown in FIG. 42B for the 3 threshold case. The horizontal axis represents an angular error (azimuth or elevation), and the vertical axis represents the angular correction applied to the target direction.

In one embodiment, when far side angular error is available, the system may be weighted more heavily to use the far side angular error.

In some embodiments, the tracking system can be implemented in software. (Such embodiments may be deployed in environments such as on buildings, where movements are expected to be slower.) The synchronization between the near side and the far side may be performed as shown in FIG. 43. The synchronization is illustrated in terms of a sequence of communications over the optical link between the near side OLU 4300 and far side OLU 4305. First, the near side sends a start request 4310 to the far side. The far side sends back a start acknowledge message 4315. The near side may start a scan of the pointing direction (a movement of the pointing direction around the target direction) upon receiving the start acknowledge message. The near side may send a request 4320 for the far side's RSSI and BER for each point during the scan. (RSSI represents “received signal strength indicator”, BER is an acronym for “bit error rate”.) The far side may send an acknowledge message 4325 including the requested RSSI and BER. When the scan is completed, the near side may update its target direction based on the received far side RSSI and BER data, and send a scan done message 4330 to the far side. When the far side receives the scan done message 4335, the far side may perform a scan of its pointing direction by exchanging the same messages as just described, but with the directions reversed. Thus, the far side initiates its scan by sending a start request 4335 to the near side. The near side returns a start acknowledge message, and so forth. The near side and far side take turns assuming the role of the scanner. The computational overhead may be very low. Thus, the rate at which the roles are exchanged may be limited by the speed the motors can traverse the scan pattern (the scan path).

In some environments, faster tracking may be required, e.g., when at least one of the OLUs is to be mounted on an unstable structure. Thus, the tracking system may be implemented in hardware (e.g., in one or more FPGAs).

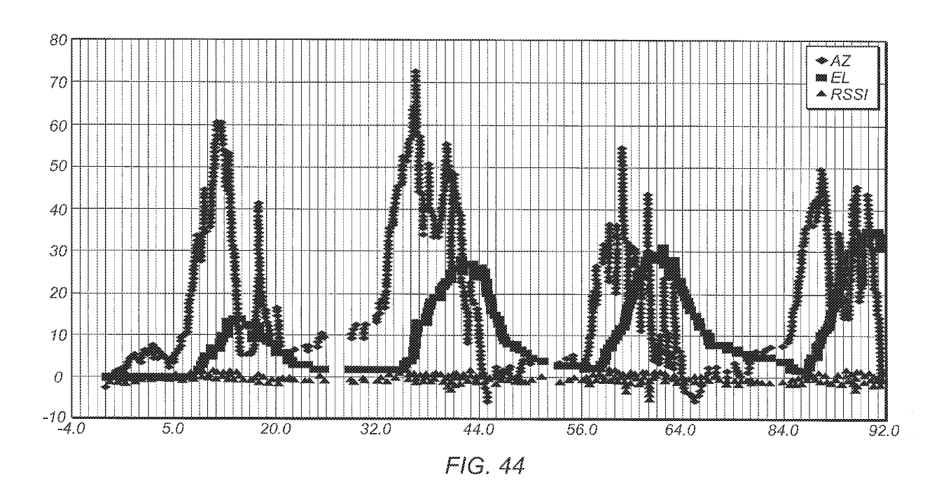

FIG. 44 shows when the active tracking is implemented, the RSSI remains constant over a period of 4 days. The active tracking moves the azimuth and elevation over the course of the day to keep the near side lens (lenses) pointed at the far side lens (lenses) in spite of movements of the mounting structure (e.g., building or tower). The azimuth plot is the largest signal; the elevation plot is the signal of intermediate amplitude; and the RSSI is the smallest signal (near zero).

Tracking Algorithm

The mutual adaptive tracking algorithm may be used to adaptively align free-space optical systems. The mutual adaptive tracking algorithm may involve the combining of both near side and far side reaction to scanning.

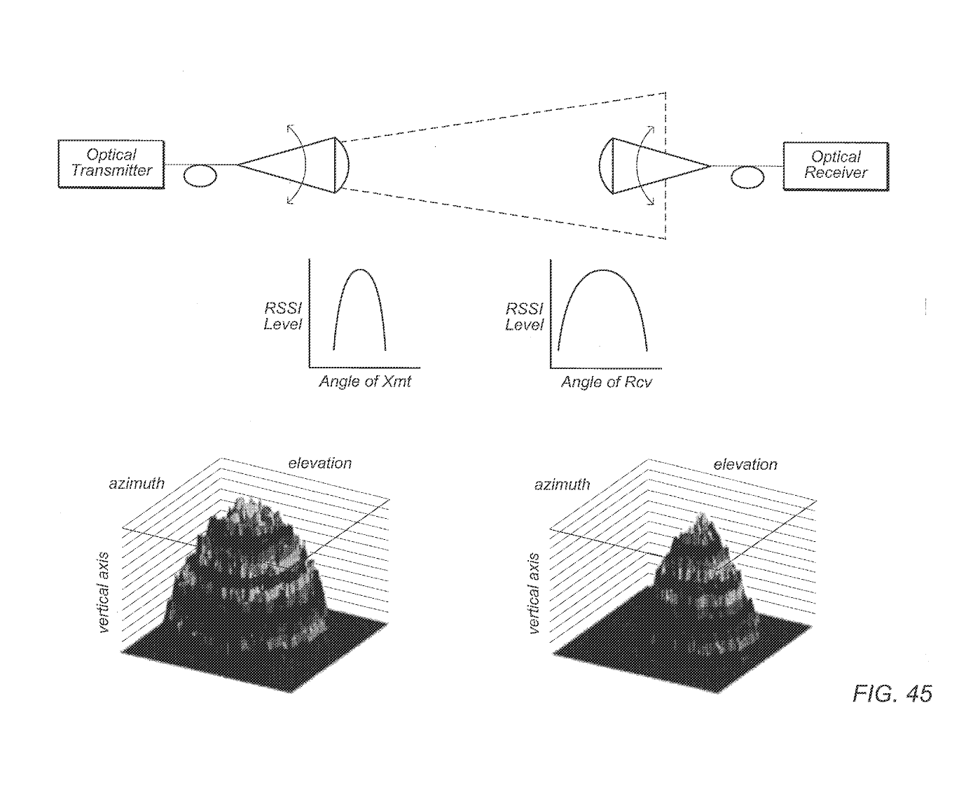

In some embodiments, the tracking algorithm uses both near side and far side data to determine position corrections in azimuth, elevation or both, to maintain optimal bi-directional communication. FIG. 45 illustrates the significance of using both near side and far side data. As the angle of the transmitter or receiver is moved off optimal alignment, the receive level is reduced. The graphs in FIG. 45 show the relative impact on receive level as misaligning the transmitter or receiver. (In other words, FIG. 45 shows the receive signal strength for both near side and far side relative to beam alignment.) The receive level is most sensitive to transmitter alignment, while the receiver alignment allows for wider reception angles. Combining both increases the reliability, and enables the compensation of collimation errors.

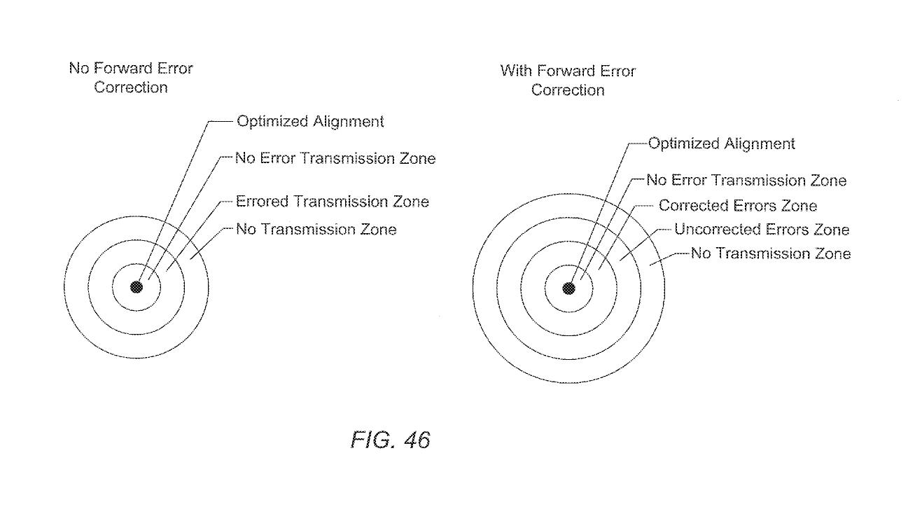

As free-space optical beams are misaligned from optimized alignment position, communication transitions from error free transmission zones, to errored transmission zones, then with continued misalignment to no transmission zone. Forward error correction can be used to increase the amount of misalignment before transmission is impacted. FIG. 46 illustrates this for free-space optical systems with and without forward error correction (FEC). The size of the error free zone allows for scanning without impacting the communication link. The scan size is preferably chosen to be well within the error free transmission zone once the systems are aligned.

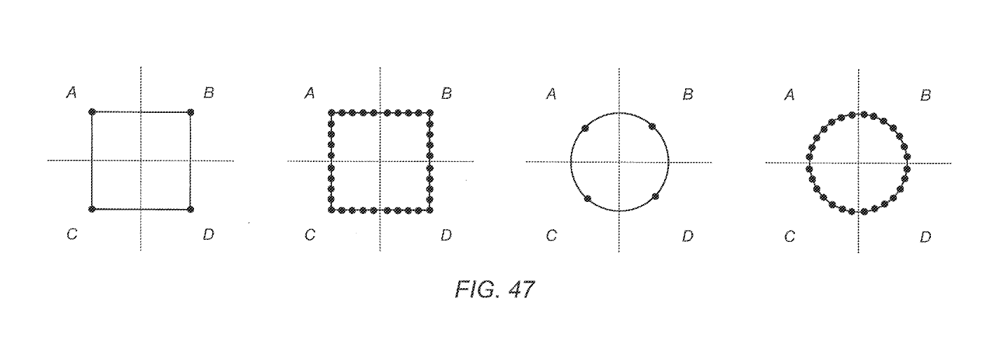

FIG. 47 illustrates examples of square and circular scanning patterns. (However, a wide variety of other patterns are possible and contemplated.) During the scan, a signal strength value may be established for each of the four quadrants whether the scan is in a square or circle pattern, and whether a single measurement point or multiple measurement points are used in each quadrant.

As a result of a scan, the following four near side values may be obtained:

ΣAₙ,ΣBₙ,ΣCₙ,ΣDₙ,

and the following four far side values:

ΣA_{f},ΣB_{f},ΣC_{f},ΣD_{f}.

The expression ΣAₙ denotes the summation of the received signal strength measurements obtained by the near side (the local node) in quadrant A. The other near side expressions are similarly defined. The expression ΣA_{f} denotes the summation of the received signal strength measurements obtained by the far side (the remote node) in quadrant A. The other far side expressions are similarly defined.

Note that the second pattern from left in FIG. 47 has nine points per quadrant. Thus, if both the near side and far side use that pattern for making measurements during the scan, there will be nine terms in each of the eight summations listed above. However, the leftmost pattern in FIG. 47 has only one point per quadrant. Thus, each of the summations will be trivial, being equal to its one and only term.

From these eight measured values, the reciprocal tracking algorithm may calculate the following values:

Near Side Azimuth Adjust Factor=ΣAₙ−ΣBₙ+ΣCₙ−ΣDₙ,

Near Side Elevation Adjust Factor=ΣAₙ+ΣBₙ−ΣCₙ−ΣDₙ,

Far Side Azimuth Adjust Factor=ΣA_{f}−ΣB_{f}+ΣC_{f}−ΣD_{f},

Far Side Elevation Adjust Factor=ΣA_{f}+ΣB_{f}−ΣC_{f}−D_{f}.

The mutual adaptive tracking algorithm may apply thresholds to the adjust factors, and different weights to near side vs. far side factors, resulting in the determination of reliable movement direction and any necessary acceleration to maintain reliable free-space optical communications.

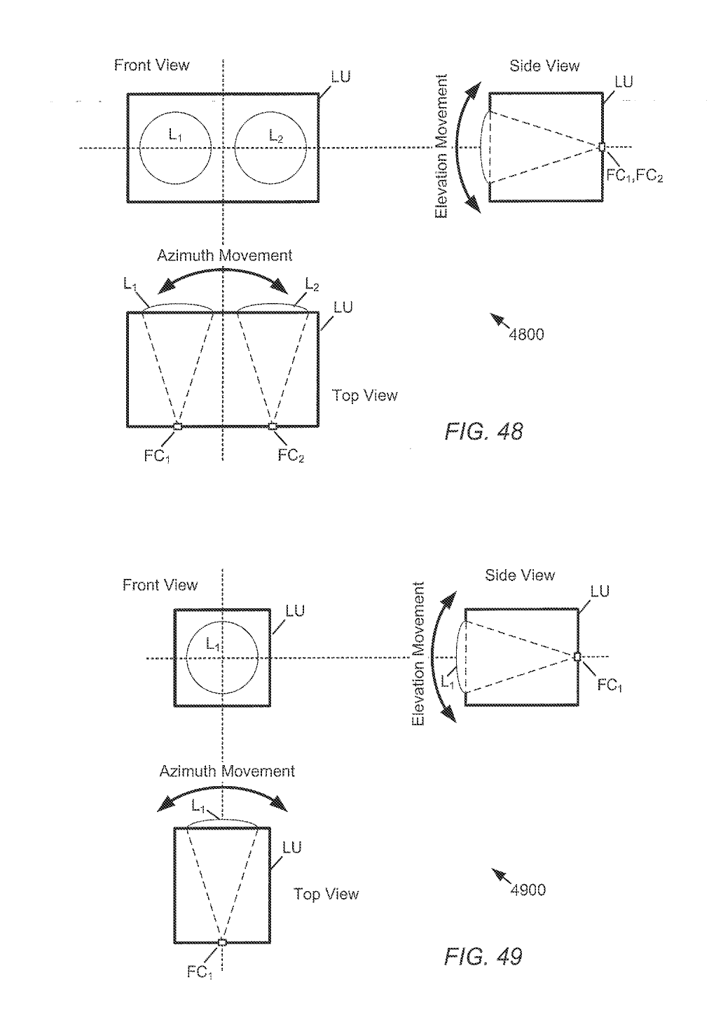

FIG. 48 shows an example of a two-lens configuration 4800 of a lens unit LU (e.g., lens unit 120 or lens unit 1810 or lens unit 2420 or outdoor lens unit 3120). The lens unit includes lenses L₁ and L₂. One of the lenses is used for transmission and the other lens for reception. The chassis (housing) of the lens unit LU may include fiber optic connectors FC₁ and FC₂ for coupling to respective optical fibers (or fiber optic cables). The lens unit LU is configured for controlled movement in both elevation and azimuth. The elevation movement is indicated in the side view. The azimuth movement is indicated in the top view. The mutual adaptive tracking algorithm manages the scanning of the lens unit LU, and determines the elevation and azimuth angle adjustments to maintain communication integrity. The mutual adaptive tracking algorithm coordinates the scanning and movement between the near and far sides.

FIG. 49 shows an example of a single-lens configuration 4900 of the lens unit LU. The single-lens configuration 4900 has a single lens L₁ (or alternatively, a single optical path having one or more lenses), and may be used to both transmit and receive. Transmission and reception may be performed over a single optical path by employing wavelength-division multiplexing.

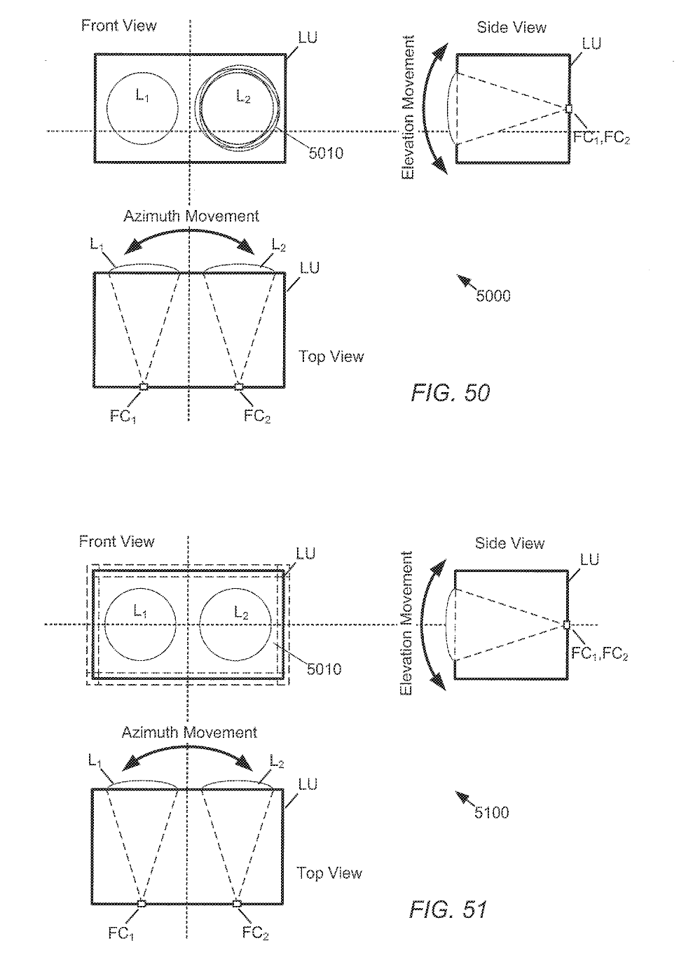

FIGS. 50 and 51 show alternative embodiments in which the azimuth-adjusting motor and the elevation adjusting motor are used to make adjustments to the target direction TD, and one or more additional motors are used to scan the pointing direction PD around the target direction. These embodiments may be used to achieve high scanning rates, and thus, to enable tracking under the more demanding twist and sway conditions of communication towers or other such unstable structures. In some embodiments, the one or more additional motors may be high reliability piezoelectric motors.

In the embodiment of FIG. 50, a third motor may be used to move the pointing direction of the transmit beam relative to the lens unit LU. See label 5010. For example, the third motor may be configured to move the fiber of the transmit cell in order to generate the scanning motion. (See FIGS. 6A-C and 7A-C, and the corresponding textual description.) This has the advantage that only a minimal mass (the mass of the fiber) is moved to perform scanning and thus improves system reliability. In one embodiment, the fiber is translated in the X and Y directions (e.g., using two motors, i.e., one for each coordinate). Alternatively, the fiber may be moved in angle. In some embodiments, the third motor can have a large range of motion to correct collimation error and/or to provide temperature compensation (to maintain low collimation error across temperature).

In the embodiment of FIG. 51, two additional motors are used to scan the pointing direction of the whole lens unit LU or the whole optics assembly relative to the target direction. For example, the lens unit LU and the two additional motors may be mounted on a platform whose azimuth and elevation are controlled by the azimuth-adjusting motor and the elevation-adjusting motor.

A wide variety of embodiments of system and methods are disclosed above. Any subset of those embodiments may be combined to form composite embodiments, as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An optical communication system comprising:
a transmitter configured to modulate a first data stream onto a first optical signal to obtain a modulated first optical signal;
a lens unit including at least a first lens, wherein the first lens is configured to transmit the modulated first optical signal into space as a first beam;
a set of one or more motors configured to adjust a pointing direction of the first beam;
a control unit configured to control the one or more motors so as to move the pointing direction of the first beam through a path centered on a current target direction, wherein the control unit is configured to receive feedback information generated by a remote optical communication system, wherein the feedback information includes or is based on measurements of strength of the first beam as received by the remote optical communication system during the movement of the pointing direction of the first beam through the path, wherein the control unit is configured to control the one or more motors so as to adjust the target direction of the first lens based on a data set including the feedback information.

2. The optical communication system of claim 1, wherein the transmitter is configured to perform forward error correction (FEC) encoding on the first data stream prior to said modulation.

3. The optical communication system of claim 1, further comprising only one laser device, wherein the laser device is a multimode laser device, wherein the laser device is configured to generate the first optical signal, wherein the first optical signal is a multimode optical signal.

4. The optical communication system of claim 1, wherein the control unit is configured to receive portions of the feedback information during the movement of the pointing direction through the path, and to make corresponding adjustments to the target direction during the movement of the pointing direction.

5. The optical communication system of claim 1, wherein the transmitter and at least a portion of the control unit are incorporated in a terminal unit, wherein the terminal unit is configured for coupling to the lens unit via one or more cables, wherein the terminal unit is configured to supply the modulated first optical signal to the lens unit through the one or more cables, wherein the lens unit is configured for outdoor operation.

6. The optical communication system of claim 5, wherein the terminal unit is also configured to supply power to the lens unit through the one or more cables.

7. The optical communication system of claim 5, wherein the lens unit includes a rain-proof enclosure.

8. The optical communication system of claim 1, further comprising a network interface, wherein the network interface is configured to receive data from an external network and to inject the data from the external network into the first data stream.

9. The optical communication system of claim 8, wherein the network interface is configured to support a plurality of network clients simultaneously, wherein the data received from the external network includes data from each of the network clients.

10. The optical communication system of claim 8, wherein the network interface includes one or more ports for interfacing with the external network, wherein one or more of the ports are configured to convey power as well as data.

11. The optical communication system of claim 1, wherein the transmitter, the lens unit, the set of one or more motors, and the control unit are incorporated into a single integrated package.

12. The optical communication system of claim 1, wherein the feedback information includes the strength measurements.

13. The optical communication system of claim 1, further comprising a first optical fiber configured to convey the modulated first optical signal from the transmitter to the first lens.

14. The optical communication system of claim 13, wherein the one or more motors are configured to adjust the pointing direction of the first beam by translating an end of the first optical fiber relative to the first lens.

15. The optical communication system of claim 13, wherein the one or more motors are configured to adjust the pointing direction of the first beam by adjusting an angle of an end of the first optical fiber relative to the first lens.

16. The optical communication system of claim 1, wherein the first beam has a Gaussian transmission pattern.

17. The optical communication system of claim 1, wherein the set of one or more motors are configured to adjust the pointing direction by adjusting an angular orientation of the lens unit, wherein the set of one or more motors includes at least an azimuth-adjusting motor and an elevation-adjusting motor.

18. The optical communication system of claim 1, wherein the path is a rectangular path.

19. The optical communication system of claim 1, wherein the control unit includes a programmable hardware element.

20. The optical communication system of claim 19, wherein the programmable hardware element is configured to buffer the first data stream in a memory and to retransmit portions of the first data stream in response to determining that the remote optical communication system has not acknowledged receipt of those portions.

21. The optical communication system of claim 1, wherein the control unit includes a processor configured to execute program instructions.

22. The optical communication system of claim 1, wherein the control unit is configured to compute an azimuth error based on the feedback information, wherein said adjusting the target direction of the first lens includes adjusting an azimuth angle of the target direction only if the computed azimuth error is greater than an azimuth error threshold.

23. The optical communication system of claim 1, wherein the control unit is configured to compute an elevation error based on the feedback information, wherein said adjusting the target direction of the first lens includes adjusting an elevation angle of the target direction only if the computed elevation error is greater than an elevation error threshold.

24. The optical communication system of claim 1, further comprising a receiver;
wherein the first lens is configured to receive a second optical signal from the space, wherein the second optical signal is transmitted from the remote optical communication system;
wherein the receiver is configured to recover a second data stream from the received second optical signal, and extract the feedback information from the second data stream, wherein the receiver is further configured to capture measurements of strength of the received second optical signal during the movement of the pointing direction of the first beam through the path.

25. The optical communication system of claim 24, wherein the receiver includes an optical filter configured to filter the received second optical signal in order to attenuate wavelength components in one or more noise-bearing wavelength bands.

26. The optical communication system of claim 24, wherein the transmitter, the receiver and at least a portion of the control unit are incorporated in a terminal unit, wherein the terminal unit is configured for coupling to the lens unit via one or more cables, wherein the terminal unit is configured to supply the modulated first optical signal to the lens unit through the one or more cables, wherein the lens unit is configured to supply the received second optical signal to the terminal unit through the one or more cables, wherein the lens unit is configured for outdoor operation.

27. The optical communication system of claim 26, wherein the one or more cables include a hybrid electro-optic cable, wherein the hybrid electro-optic cable includes two or more optical fibers and a plurality of electrical conductors.

28. The optical communication system of claim 27, wherein the plurality of electrical conductors includes a first pair that is configured to convey power from the terminal unit to the lens unit.

29. The optical communication system of claim 24, further comprising a network interface, wherein the network interface is configured to receive first data packets from an external network and to inject the first data packets into the first data stream, wherein the network interface is further configured to extract second data packets from the second data stream and to transmit the second data packets onto the external network.

30. The optical communication system of claim 24, wherein the transmitter, the receiver, the lens unit, the set of one or more motors, and the control unit are incorporated into a single integrated package.

31. The optical communication system of claim 24, wherein the data set also includes the strength measurements captured by the receiver.

32. The optical communication system of claim 24, further comprising:
a first optical fiber configured to convey the modulated first optical signal from the transmitter to the first lens; and
a second optical fiber configured to convey the received second optical signal from the first lens to the receiver.

33. The optical communication system of claim 24, wherein the control unit is further configured to inject messages for the remote optical communication system into the first data stream, wherein each of the messages indicates a corresponding point along the path.

34. The optical communication system of claim 33, wherein the remote optical communication system is configured to recover the first data stream, and to synchronize the measurements of the strength of the first beam with reception of the messages.

35. The optical communication system of claim 24, wherein the control unit is configured to compute an angular error based on the feedback information and the strength measurements captured by the receiver, wherein the control unit is also configured to control the one or more motors so as to adjust the target direction based on the angular error.

36. The optical communication system of claim 1, further comprising a receiver;
wherein the lens unit also includes a second lens, wherein the second lens is configured to receive a second optical signal from the space, wherein the second optical signal is transmitted from the remote optical communication system;
wherein the receiver is configured to recover a second data stream from the received second optical signal, and to extract the feedback information from the second data stream, wherein the receiver is further configured to capture measurements of strength of the received second optical signal during the movement of the pointing direction through the path.

37. The optical communication system of claim 36, wherein the receiver includes an optical filter configured to filter the received second optical signal in order to attenuate wavelength components in one or more noise-bearing wavelength bands.

38. The method of claim 36, wherein the transmitter, the receiver and at least a portion of the control unit are incorporated in a terminal unit, wherein the terminal unit is configured for coupling to the lens unit via one or more cables, wherein the terminal unit is configured to supply the modulated first optical signal to the lens unit through the one or more cables, wherein the lens unit is configured to supply the received second optical signal to the terminal unit through the one or more cables, wherein the lens unit is configured for outdoor operation.

39. The optical communication system of claim 38, wherein the one or more cables include a hybrid electro-optic cable, wherein the hybrid electro-optic cable includes two or more optical fibers and a plurality of electrical conductors

40. The optical communication system of claim 39, wherein the plurality of electrical conductors includes a first pair that is configured to convey power from the terminal unit to the lens unit.

41. The optical communication system of claim 36, further comprising a network interface, wherein the network interface is configured to receive first data packets from an external network and to inject the first data packets into the first data stream, wherein the network interface is further configured to extract second data packets from the second data stream and to transmit the second data packets onto the external network.

42. The optical communication system of claim 36, wherein the transmitter, the receiver, the lens unit, the set of one or more motors, and the control unit are incorporated into a single integrated package.

43. The optical communication system of claim 36, wherein the data set also includes the measurements captured by the receiver.

44. The optical communication system of claim 36, further comprising:
a first optical fiber configured to convey the modulated first optical signal from the transmitter to the first lens; and
a second optical fiber configured to convey the received second optical signal from the second lens to the receiver.

45. The optical communication system of claim 36, wherein the control unit is further configured to inject messages for the remote optical communication system into the first data stream, wherein each of the messages indicates a corresponding relative position along the path.

46. The optical communication system of claim 36, wherein the first and second lenses are mounted in the lens unit so that their optical axes are parallel.

47. The optical communication system of claim 36, wherein the control unit is configured to compute an angular error based on the feedback information and the measurements captured by the receiver, wherein the control unit is also configured to control the one or more motors so as to adjust the target direction based on the angular error.

48. A method for operating an optical communication system, the method comprising:
modulating a first optical signal with a first data stream to obtain a modulated first optical signal;
transmitting the modulated first optical signal as a first beam into space through a first lens;
moving a pointing direction of the first beam through a path centered on a target direction, wherein said moving is performed during said transmitting of the modulated first optical signal;
receiving feedback information generated by a remote optical communication system, wherein the feedback information includes or is based on measurements of strength of the modulated first optical signal as received by the remote optical communication system during the movement of the pointing direction;
adjusting the target direction of the first lens based on a data set including the feedback information.

49. The method of claim 48, further comprising:
performing forward error correction (FEC) encoding on the first data stream prior to said modulating.

50. The method of claim 48, wherein said receiving feedback information includes receiving portions of the feedback information during the movement of the pointing direction through the path, wherein said adjusting the target direction includes making a plurality of adjustments to the target direction during the movement of the pointing direction through the path, each of the adjustments corresponding to a respective one of the portions.

51. The method of claim 48, further comprising:
receiving a second optical signal from the space through the first lens, wherein the second optical signal is transmitted into the space from the remote optical communication system;
recovering a second data stream from the received second optical signal, wherein said receiving the feedback information includes extracting the feedback information from the second data stream;
capturing measurements of signal strength of the received second optical signal during the movement of the pointing direction;
wherein the data set also includes the captured measurements.

52. The method of claim 51, further comprising:
optically filtering the received second optical signal prior to said recovering in order to remove noise.

53. The method of claim 48, further comprising:
receiving a second optical signal from the space through a second lens, wherein the second optical signal is transmitted into the space from the remote optical communication system;
recovering a second data stream from the received second optical signal, wherein said receiving the feedback information comprises extracting the feedback information from the second data stream;
capturing measurements of signal strength of the received second optical signal during the movement of the pointing direction;
wherein the data set also includes the captured measurements.

54. The method of claim 53, further comprising:
optically filtering the received second optical signal prior to said recovering in order to remove noise.

55. The method of claim 48, wherein the path is a rectangular path.

56. The method of claim 48, further comprising:
sending a control token to the remote optical communication system to enable the remote optical communication system to initiate a process of adjusting a transmitted beam of the remote optical communication system.

57. The method of claim 48, wherein said moving, said receiving and said adjusting are repeated at a rate that is programmable.

58. The method of claim 48, further comprising computing an angular error based on the feedback information, wherein said adjusting the target direction is performed only if the angular error is greater than a given threshold.

59. The method of claim 48, wherein said moving the pointing direction of the first beam includes moving a pointing direction of a lens unit that contains the first lens.

60. The method of claim 48, wherein said moving the pointing direction of the first beam comprises moving an end of an optical fiber relative to the first lens.

61. The method of claim 60, wherein said moving the end of the optical fiber relative to the first lens includes translating the end of the optical fiber relative to the first lens.

62. The method of claim 60, wherein said moving the end of the optical fiber relative to the first lens includes adjusting an angle of the end of the optical fiber relative to the first lens.

63. The method of claim 48, further comprising:
buffering the first data stream in a memory; and
retransmitting portions of the first data stream in response to determining that the remote optical communication system has not acknowledged receipt of those portions, wherein said retransmitting includes modulating the first optical signal with those portions, wherein said buffering and retransmitting are controlled by a programmable hardware element.

64. An optical communication system comprising:
a lens unit comprising a first lens, wherein the first lens is configured to receive a first optical signal from space, wherein the first optical signal is transmitted from a remote optical communication system;
a set of one or more motors configured to adjust a pointing direction of the first lens;
a control unit configured to control the one or more motors so as to move the pointing direction of the first lens through a path centered on a current target direction;
a receiver configured to capture measurements of strength of the received first optical signal while the pointing direction is moved through the path, wherein the control unit is configured to control the one or more motors so as to adjust the target direction based on a data set including the captured measurements.

65. The optical communication system of claim 64, wherein the receiver is configured to recover a first data stream from the received first optical signal, and perform forward error correction (FEC) decoding on the first data stream to obtain a decoded data stream.

66. The optical communication system of claim 64, wherein the first optical signal is a multimode optical signal, wherein said receiver is the only optical receiver in the optical communication system.

67. The optical communication system of claim 64, wherein the control unit is configured to make a plurality of adjustments to the target direction during the movement of the pointing direction through the path, where each of the adjustments is based on a corresponding subset of the strength measurements.

68. The optical communication system of claim 64, wherein the receiver and at least a portion of the control unit are incorporated in a terminal unit, wherein the terminal unit is configured for coupling to the lens unit via one or more cables, wherein the lens unit is configured to supply the received first optical signal to the terminal unit through the one or more cables, wherein the lens unit is configured for outdoor operation.

69. The optical communication system of claim 68, wherein the terminal unit is also configured to supply power to the lens unit through the one or more cables.

70. The optical communication system of claim 68, wherein the lens unit includes a rain-proof enclosure.

71. The optical communication system of claim 64, further comprising a network interface, wherein the receiver is configured to recover a first data stream from the received first optical signal, wherein the network interface is configured to extract data packets from the first data stream and to transmit the data packets onto an external network.

72. The optical communication system of claim 71, wherein the network interface is configured to support a plurality of network clients simultaneously, wherein the data packets transmitted onto the external network includes data packets for each of the network clients.

73. The optical communication system of claim 71, wherein the network interface includes one or more ports for interfacing with the external network, wherein one or more of the ports are configured to convey power as well as data.

74. The optical communication system of claim 64, wherein the receiver, the lens unit, the set of one or more motors, and the control unit are incorporated into a single integrated package.

75. The optical communication system of claim 64, further comprising a first optical fiber configured to convey the received first optical signal from the first lens to the receiver.

76. The optical communication system of claim 64, wherein the first lens has a Gaussian sensitivity pattern to received optical power.

77. The optical communication system of claim 64, wherein the set of one or more motors includes at least an azimuth-adjusting motor and an elevation-adjusting motor.

78. The optical communication system of claim 64, wherein the path is a rectangular path.

79. The optical communication system of claim 64, wherein the control unit comprises a programmable hardware element.

80. The optical communication system of claim 64, wherein the control unit comprises a processor configured to execute program instructions.

81. The optical communication system of claim 64, wherein the control unit is configured to compute an azimuth error based on the captured measurements and to control the one or more motors based on the computed azimuth error in order to adjust an azimuth angle of the target direction.

82. The optical communication system of claim 64, wherein the control unit is configured to compute an elevation error based on the captured measurements and to control the one or more motors based on the computed elevation error in order to adjust an elevation angle of the target direction.

83. The optical communication system of claim 64, further comprising a transmitter;
wherein the receiver is configured to recover a first data stream from the received first optical signal;
wherein the transmitter is configured to modulate a second data stream onto a second optical signal to obtain a modulated second optical signal;
wherein the first lens is configured to transmit the modulated second optical signal into space as a first beam;
wherein the control unit is configured to extract feedback information from the first data stream, wherein the feedback information is generated by the remote optical communication system, wherein the feedback information includes or is based on measurements of strength of the first beam as received by the remote optical communication system during the movement of the pointing direction of the first lens through the path, wherein the data set also includes the feedback information.

84. The optical communication system of claim 64, further comprising a transmitter;
wherein the receiver is configured to recover a first data stream from the received first optical signal;
wherein the transmitter is configured to modulate a second data stream onto a second optical signal to obtain a modulated second optical signal, wherein said movement of the pointing direction of the first lens through the path also moves a pointing direction of the second lens through the same path;
wherein the lens unit also includes a second lens, wherein the second lens is configured to transmit the modulated second optical signal into space as a beam;
wherein the control unit is configured to extract feedback information from the first data stream, wherein the feedback information is generated by the remote optical communication system, wherein the feedback information includes or is based on measurements of strength of the first beam as received by the remote optical communication system during the movement of the pointing direction of the first lens through the path, wherein the data set also includes the feedback information.

85. A method for operating an optical communication system in order to acquire communication with a remote optical communication system, the method comprising:
receiving a first optical signal from a space through a first lens, wherein the first optical signal is transmitted into the space from the remote optical communication system;
moving a pointing direction of the first lens through a first path centered on a target direction;
capturing measurements of signal strength of the received first optical signal during the movement of the pointing direction;
adjusting the target direction of the first lens based on the captured measurements.

86. The method of claim 85, further comprising:
recovering a first data stream from the received first optical signal; and
performing forward error correction (FEC) decoding on the first data stream to obtain a decoded data stream.

87. The method of claim 85, wherein said adjusting the target direction includes making a plurality of adjustments to the target direction during the movement of the pointing direction through the path, wherein each of the adjustments is based on corresponding subject of the captured measurements.

88. The method of claim 85, further comprising:
repeating said moving, said capturing and said adjusting using successively smaller sizes for the first path.

89. The method of claim 85, further comprising:
recovering a first data stream from the received first optical signal;
modulating a second optical signal with a second data stream to obtain a modulated second optical signal;
transmitting the modulated second optical signal into space through the first lens.

90. The method of claim 89, further comprising:
after said adjusting the target direction based on the captured measurements, performing a set of operations including:
moving the pointing direction of the first lens through a second path centered on the target direction during said transmitting of the modulated second optical signal;
extracting feedback information from the first data stream, wherein the feedback information includes or is based on measurements of strength of the modulated second optical signal as received by the remote optical communication system during said movement of the pointing direction through the second path;
capturing additional measurements of signal strength of the received first optical signal during the movement of the pointing direction through the second path;
performing a tracking adjustment of the target direction of the first lens based on the feedback information and/or the captured additional measurements.

91. The method of claim 85, further comprising:
recovering a first data stream from the received first optical signal;
modulating a second optical signal with a second data stream to obtain a modulated second optical signal;
transmitting the modulated second optical signal into space through a second lens.

92. The method of claim 91, further comprising:
after said adjusting the target direction based on the captured measurements, performing a set of operations including:
moving the pointing direction of the second lens through a second path centered on the target direction during said transmitting of the modulated second optical signal;
extracting feedback information from the first data stream, wherein the feedback information includes or is based on measurements of strength of the modulated second optical signal as received by the remote optical communication system during said movement of the pointing direction of the second lens through the second path;
capturing additional measurements of signal strength of the received first optical signal during the movement of the pointing direction of the second lens through the second path;
performing a tracking adjustment of the target direction of the first lens based on the feedback information and/or the captured additional measurements.

93. An optical communication system comprising:
a transmitter configured to modulate a first data stream onto a first optical signal to obtain a modulated first optical signal;
a lens unit configured to transmit the modulated first optical signal into space, wherein the lens unit is also configured to receive a second optical signal from the space, wherein the second optical signal is transmitted as a beam from a remote optical communication system;
a receiver configured to recover a second data stream from the received second optical signal, wherein the receiver is further configured to capture measurements of strength of the received second optical signal while the remote optical communication system moves a pointing direction of the beam through a path centered on a target direction;
a control unit configured to embed feedback information into the first data stream to enable the remote optical communication system to correct the target direction of the beam, wherein the feedback information comprises the captured measurements or data derived from the captured measurements.

94. The optical communication system of claim 93, wherein the transmitter is configured to perform forward error correction (FEC) encoding on the first data stream prior to said modulating, wherein the receiver is configured to perform FEC decoding on the second data stream after said recovering the second data stream from the received second optical signal.

95. The optical communication system of claim 93, further comprising only one laser device, wherein the laser device is a multimode laser device, wherein the laser device is configured to generate the first optical signal, wherein the first optical signal is a multimode optical signal.

96. The optical communication system of claim 93, wherein the transmitter, the receiver and at least a portion of the control unit are incorporated in a terminal unit, wherein the terminal unit is configured for coupling to the lens unit via one or more cables, wherein the terminal unit is configured to supply the modulated first optical signal to the lens unit through the one or more cables, wherein the lens unit is configured to supply the received second optical signal to the terminal unit through the one or more cables, wherein the lens unit is configured for outdoor operation.

97. The optical communication system of claim 93, wherein the transmitter, the receiver, the lens unit, and the control unit are incorporated into a single integrated package.

98. The optical communication system of claim 93, wherein the path is a rectangular path.

99. The optical communication system of claim 93, wherein the control unit comprises a programmable hardware element.

100. The optical communication system of claim 93, wherein the control unit comprises a processor configured to execute program instructions.

101. The optical communication system of claim 93, wherein the transmitter is configured to modulate the first data stream onto the first optical signal using a first set of one or more wavelengths, wherein the second optical signal includes a second set of one or more wavelengths, wherein the first set of wavelengths and the second set of wavelengths are disjoint.

102. The optical communication system of claim 93, wherein the lens unit includes a single lens, wherein the single lens is configured to transmit the modulated first optical signal into the space and receive the second optical signal from the space.

103. The optical communication system of claim 93, wherein the lens unit includes a first lens and a second lens, wherein the first lens is configured to transmit the modulated first optical signal into the space, wherein the second lens is configured to receive the second optical signal from the space.

104. The optical communication system of claim 93, wherein the control unit is configured to extract messages from the second data stream, wherein the messages are generated by the remote optical communication system and indicate respective positions along the path, wherein the control unit is configured to synchronize the capture of the strength measurements with the messages.

105. A method for operating an optical communication system, the method comprising:
modulating a first data stream onto a first optical signal to obtain a modulated first optical signal;
transmitting the modulated first optical signal into space through a lens unit;
receiving a second optical signal from the space through the lens unit, wherein the second optical signal is transmitted as a beam from a remote optical communication system;
capturing measurements of signal strength of the received second optical signal while the remote optical communication system moves a pointing direction of the beam through a path centered on a target direction;
injecting signal strength information into the first data stream, wherein the signal strength information is based on the captured measurements, wherein the signal strength information is usable by the remote optical communication system to adjust the target direction of the beam.

106. The method of claim 105, further comprising:
performing forward error correction (FEC) encoding on the first data stream prior to said modulating.

107. The method of claim 105, further comprising:
receiving first data packets from an external network;
injecting the first data packets into the first data stream;
recovering a second data stream from the received second optical signal; and
providing second data packets from the second data stream to the external network.

108. The method of claim 105, further comprising:
recovering a second data stream from the received second optical signal;
extracting synchronization messages from the second data stream, wherein the synchronization messages indicate respective positions along the path, wherein said capturing of signal strength measurements is synchronized with the synchronization messages.

109. The method of claim 108, further comprising:
computing an azimuth error and/or an elevation error of the target direction based on the captured measurements, wherein the signal strength information includes the azimuth error and/or the elevation error.

110. The method of claim 105, wherein the path is a piecewise linear path.
